(19) United States
(12) Patent Application Publication
(10) Pub. No.: US 2025/0033517 A1
(43) Pub. Date: Jan. 30, 2025

(54) ELECTRIC VEHICLE FLEET CHARGING AND ENERGY MANAGEMENT SYSTEM

(71) Applicant: Cowan & Associates Management Ltd., Victoria (CA)

(72) Inventors: Jordan Frances HANCOCK, Victoria (CA); Jordan Ashton COWAN, Victoria (CA); Peter Cameron COWAN, Victoria (CA); Martin Andrew HANCOCK, Victoria (CA)

(21) Appl. No.: 18/696,938

(22) PCT Filed: Sep. 27, 2022
(86) PCT No.: PCT/CA2022/051432

§ 371 Date: Mar. 28, 2024

Related U.S. Application Data
(60) Provisional application No. 63/251,246, filed on Oct. 1, 2021.

(51) Int. Cl. B60L 53/68; B60L 53/62; B60L 53/63; B60L 53/66

(52) U.S. Cl. CPC B60L 53/68; B60L 53/62; B60L 53/63; B60L 53/66; B60L 2240/72

(57) ABSTRACT

A system and method for directing energy use within a facility comprising charging stations for charging a fleet of electric vehicles, using an energy optimisation engine. The energy optimisation engine receives energy supply characteristics and facility operational energy consumption characteristic of energy assets associated with the facility over a first time period, and electrical vehicle operational requirements for the electric vehicles during a second period; computes energy distribution instructions for the first time period and satisfying a designated energy condition corresponding at least in part with the energy supply characteristics; and directs operation of the charge stations or the energy assets in accordance with the energy distribution instructions.

### RELATED APPLICATION

The instant application claims the benefit of priority to U.S. Provisional Patent Application Ser. No. 63/251,246, entitled: “ELECTRIC VEHICLE FLEET CHARGING AND ENERGY MANAGEMENT SYSTEM” and filed Oct. 1, 2021, the contents of which is fully incorporated herein by reference.

### FIELD OF THE DISCLOSURE

The present disclosure relates to electric vehicle charging, and, in particular, to electric vehicle fleet charging and energy management systems and methods.

### BACKGROUND

The charging of commercial or residential electric vehicle (EV) fleets currently lacks a solution that balances both the load of the charging facility or building, and the charging of the vehicles. Non-intelligent and/or unscheduled charging of entire fleets of EVs often cause a facility to set a new Peak Demand each day, or over a specific time period, as fleet vehicles typically arrive back at the facility around the same time. Additionally, charging could also commence at a high Time of Use cost period. This may be expensive for facility owners, as well as worrisome for the energy grid, as the energy grid may not have the infrastructure to adequately handle the load required for simultaneously charging entire fleets of electric vehicles, while still maintaining energy delivery to the entire grid, and/or delivering the charging at a lower cost to the consumer.

Many companies have started to Smart Charge electric vehicles based on Time of Use periods. This typically consists of delayed or scheduled charging to match low-cost energy periods.

This type of charging might not be beneficial to fulfillment or other types of energy consuming facilities as other facility loads come into play, and new peaks may be hit within the facility, even when following a Time of Use schedule.

The addition of on-site energy alternatives further complicates the issue, as many Building Management Systems lack the connection and insight to include Electric Vehicle charging. Further, even BMS systems that do contemplate EV charging needs within a building or site area do not address the predicted or actual use of EV fleets as part of the operations required by the fleet (e.g. delivery needs related to route planning, scheduling, or general EV or autonomous robot use that requires the charging).

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for an electric vehicle fleet charging and energy management system that overcomes some of the drawbacks of known techniques, or at least, provides a useful alternative thereto. Some aspects of this disclosure provide examples of such systems and methods.

In accordance with one aspect, there is provided a system for directing energy use within a facility comprising one or more charge stations for charging a fleet of electric vehicles. The system comprises an energy optimisation engine configured to receive as input energy supply data representative of energy supply characteristics over a first designated time period, facility operation energy data representative of operational energy consumption characteristics of one or more energy assets associated with the facility over said first designated time period, and vehicle operation data representative of electric vehicle operational requirements for one or more of the electric vehicles during a second designated time period. The system further comprises one or more digital data processors accessible to said energy optimisation engine and configured to compute, for said first designated time period and satisfying a designated energy management condition corresponding at least in part with said energy supply characteristics, energy distribution instructions. The energy distributions instructions comprise charging instructions for the one or more charge stations satisfying said vehicle operational requirements, and corresponding facility operation instructions for said energy assets. The energy optimisation engine is configured, for the first designated time period, to digitally direct operation of one or more of the charge stations or said energy assets in accordance with said energy distribution instructions.

In some embodiments, the first and second designated time periods correspond to at least partially overlapping time periods.

In some embodiments, the energy assets comprise one or more of an energy consuming device in the facility, an electrical load, or a utility.

In some embodiments, the charging instructions comprise one or more of a charge station activation, a charge station deactivation, a variable rate charge instruction, autonomous vehicle movement instructions, or manual vehicle movement instructions.

In some embodiments, the energy supply data comprises at least one of demand response data, an energy cost, a time-of-use penalty, an amount of energy, a demand penalty, or a predicted energy consumption.

In some embodiments, the facility operation data comprises at least one of a historical energy consumption, a current energy consumption, or a predicated energy consumption by at least one of said energy assets.

In some embodiments, the vehicle operation data comprises, for at least one of the electric vehicles, at least one of a battery capacity, a battery charge level, a rate of battery charge, a rate of battery discharge, a battery age, a battery temperature, a historical battery discharge rate, a distance to recharge, an expected vehicle weight, or data related to an expected vehicle route, a driving schedule, a driving distance, or driver.

In some embodiments, the energy distribution instructions comprise instructions to prioritize charging of at least one of the electric vehicles.

In some embodiments, the energy distribution instructions comprise instructions to reschedule charging of at least one of the electric vehicles.

In some embodiments, the energy distribution instructions comprise instructions to discharge at least one battery of the electric vehicles into one or more of a another battery, an energy grid, the facility, or one or more of said energy assets.

In some embodiments, the energy optimisation engine is configured to receive as input electric vehicle charge network data representative of a vehicle charging location that is external to the facility, and wherein said energy optimisation engine is operable to compute said energy distribution instructions in view of said electric vehicle charge network data.

In some embodiments, the energy optimisation engine is operable to compute said energy distribution instructions in accordance with an artificial intelligence process.

In some embodiments, the one or more digital data processors are further configured to automatically compute delivery management recommendations based at least in part on said vehicle operational requirements and said energy distribution instructions.

In some embodiments, the one or more digital data processors are further operable to automatically compute vehicle charge requirements based at least in part on said vehicle operational requirements.

In some embodiments, the energy optimisation engine is configured to receive as input charging authorization for authorizing said operation of the charge stations.

In some embodiments, the electric vehicle charge optimisation engine is configured to receive as input asset direction authorization for authorizing said operation of the energy assets in the facility.

In some embodiments, the energy optimisation engine is configured to digitally direct operation of said one or more of the charge stations or said energy assets via a graphical user interface (GUI) displaying to a user data related to said energy distribution instructions.

In some embodiments, the GUI is configured to receive as input execution data related to said energy distribution instructions to thereby implement at least a portion of said energy distribution instructions.

In some embodiments, the energy optimisation engine is configured to access one or more of a local server or a cloud-based server to receive as input therefrom one or more of said energy supply data, said facility operation data, said vehicle operation data, said first or said second time period, or said designated energy management condition.

In some embodiments, the system comprises one or more of the local server or the cloud-based server.

In accordance with another aspect, there is provided a method for directing energy use within a facility comprising one or more charging stations for charging a fleet of electric vehicles, the method digitally executed by an energy optimisation engine via one or more digital data processors and comprising receiving as input energy supply data representative of energy supply characteristics over a first designated time period, facility operation energy data representative of operational energy consumption characteristics of one or more energy assets associated with the facility over said first designated time period, and vehicle operation data representative of electric vehicle operational requirements for one or more of the electric vehicles during a second designated time period. The method further comprises computing, for said first designated time period and satisfying a designated energy management condition corresponding at least in part with said energy supply characteristics, energy distribution instructions comprising charging instructions for the one or more charge stations satisfying said vehicle operational requirements, and corresponding facility operation instructions for said energy assets. The method further comprises digitally directing, for said first designated time period, operation of one or more of the charge stations or said energy assets in accordance with said energy distribution instructions.

In some embodiments, the first and second designated time periods correspond to at least partially overlapping time periods.

In some embodiments, the energy assets comprise one or more of an energy consuming device in the facility, an electrical load, or a utility.

In some embodiments, the charging instructions comprise one or more of a charge station activation, a charge station deactivation, a variable rate charge instruction, autonomous vehicle movement instructions, or manual vehicle movement instructions.

In some embodiments, the energy supply data comprises at least one of demand response data, an energy cost, a time-of-use penalty, an amount of energy, a demand penalty, or a predicted energy consumption.

In some embodiments, the facility operation data comprises at least one of a historical energy consumption, a current energy consumption, or a predicated energy consumption by at least one of said energy assets.

In some embodiments, the vehicle operation data comprises, for at least one of the electric vehicles, at least one of a battery capacity, a battery charge level, a rate of battery charge, a rate of battery discharge, a battery age, a battery temperature, a historical battery discharge rate, a distance to recharge, an expected vehicle weight, or data related to an expected vehicle route, a driving schedule, a driving distance, or driver.

In some embodiments, the energy distribution instructions comprise instructions to prioritize charging of at least one of the electric vehicles.

In some embodiments, the energy distribution instructions comprise instructions to reschedule charging of at least one of the electric vehicles.

In some embodiments, the energy distribution instructions comprise instructions to discharge at least one battery of the electric vehicles into one or more of another battery, an energy grid, the facility, or one or more of said energy assets.

In some embodiments, the method comprises receiving as input electric vehicle charge network data representative of a vehicle charging location that is external to the facility, and wherein said computing said energy distribution instructions is executed at least in part in accordance with said electric vehicle charge network data.

In some embodiments, the computing said energy distribution instructions comprises an artificial intelligence-based computational process.

In some embodiments, the one or more digital data processors are further configured to automatically compute delivery management recommendations based at least in part on said vehicle operational requirements and said energy distribution instructions.

In some embodiments, the method comprises computing vehicle charge requirements based at least in part on said vehicle operational requirements.

In some embodiments, the method comprises receiving as input charging authorization for authorizing said operation of the charge stations.

In some embodiments, the method comprises receiving as input asset direction authorization for authorizing said operation of the energy assets in the facility.

In some embodiments, the digitally directing comprises, via a graphical user interface (GUI), displaying to a user data related to said energy distribution instructions.

In some embodiments, the method comprises receiving as input via said GUI execution data related to said energy distribution instructions and thereby implementing at least a portion of said energy distribution instructions.

In some embodiments, the receiving as input comprises accessing one or more of a local server or a cloud-based server and receiving therefrom one or more of said energy supply data, said facility operation data, said vehicle operation data, said first or said second time period, or said designated energy management condition.

In accordance with another aspect, there is provided a non-transitory computer-readable medium comprising digital instructions executable by one or digital data processors to execute a method as substantially herein described.

In accordance with another aspect, there is provided a system for directing energy use for a facility associated with one or more charge stations for charging an electric vehicles. The system comprises a communications interface interfacing one or more digital data processors with an external energy management interface, and the one or more digital data processors which are configured to receive as input, in association with a designated time period, energy supply data representative of energy supply characteristics, facility operation energy data representative of energy usage requirements by at least one energy asset associated with the facility, and vehicle operation data representative of electric vehicle operational requirements. The one or more digital data processors are further configured to compute for said designated time period a designated energy distribution regime at least in part based on said vehicle operation data, said facility operation energy data, and said energy supply data, and via said communications interface, digitally direct operation of the one or more charge stations and said energy asset at least in part in accordance with said energy distribution regime.

In accordance with another aspect, there is provided an energy management optimisation method, to be automatically executed by an electric vehicle charge optimisation engine, to optimise charging for a plurality of electric vehicles via a plurality of charge stations associated with a facility, the method comprising: accessing energy consumption management data comprising energy supply data representative of energy supply characteristics corresponding to at least a portion of the facility over a first designated time period, facility operation energy data representative of an energy usage by said at least a portion of the facility over said first designated time period given facility operation consumption characteristics of energy assets, and vehicle operation data representative of vehicle operational requirements for the electric vehicles during a second designated time period; automatically computing, via one or more digital data processors accessible to the electric vehicle charge optimisation engine optimal charging instructions for each of the charge stations to satisfy said vehicle operation data for said first designated time period, and corresponding facility operation consumption characteristics of said energy assets required to satisfy said optimal charging instructions given said energy supply data; and, for said first designated time period, digitally directing operation of the charge stations in accordance with said optimal charging instructions while digitally directing operation of said energy assets in the facility in accordance with said corresponding charging facility operation consumption characteristics.

In accordance with another aspect, there is provided an energy management system to optimise energy use within at least a portion of a facility comprising a plurality of charge stations for charging a plurality of electric vehicles, the system comprising: an electric vehicle charge optimisation engine operable to access energy consumption management data comprising energy supply data representative of energy supply characteristics corresponding to the at least a portion of the facility over a first designated time period, facility operation energy data representative of an energy usage by the at least a portion of the facility over said first designated time period given facility operation consumption characteristics of energy assets, and vehicle operation data representative of vehicle operational requirements for the electric vehicles during a second designated time period; one or more digital data processors accessible to said electric vehicle charge optimisation engine and configured to automatically compute optimal charging instructions for each of the charge stations to satisfy said vehicle operation data for said first designated time period, and corresponding facility operation consumption characteristics of said energy assets required to satisfy said optimal charging instructions given said energy supply data; wherein, for said first designated time period, said electric vehicle charge optimisation engine is operable to digitally direct operation of the charge stations in accordance with said optimal charging instructions while digitally directing operation of said energy assets in the facility in accordance with said corresponding charging facility operation consumption characteristics.

In accordance with another aspect, there is provided an energy management optimisation method, to be executed by an electric vehicle charge optimisation engine, for balancing energy needs in a zone having a plurality of charge stations for a plurality of electric vehicles, the method comprising: providing to the electric vehicle charge optimisation engine energy availability data, non-vehicle data representative of energy asset needs of the zone, vehicle data, and electric vehicle fleet data; digitally calculating, via one or more digital data processors accessible to the electric vehicle charge optimisation engine, an energy usage optimisation; and providing charge instructions to at least one of the charge stations, said charge instructions determined based at least in part on said energy usage optimisation.

In accordance with another aspect, there is provided a device for optimizing energy needs in a zone comprising a charge station for at least one electric vehicle, the device comprising: a digital data storage device having digitally executable instructions stored thereon; a digital data processor in communication with said digital data storage device and configured to execute said digitally executable instructions to monitor energy management data comprising energy data attributes for the zone, data attributes of the at least one electric vehicle, and at least one non-vehicle energy device in the zone, perform an energy use optimisation calculation based at least in part on said energy management data, provide a charge instruction for the at least one electric vehicle based at least in part on said energy use optimisation calculation, and provide a control instruction for said at least one non-vehicle energy device in the zone based at least in part on said energy use optimisation calculation.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIGS. 1a and 1b are schematics of exemplary energy direction architectures as they relate to exemplary components of exemplary vehicle infrastructures, and FIG. 1c is a diagram of an exemplary energy direction optimisation process, in accordance with various embodiments;

FIG. 2 is a diagram of an exemplary energy recommendation engine, in accordance with one embodiment;

FIG. 3 is a schematic of an exemplary machine learning architecture for executing an energy direction process, in accordance with one embodiment;

FIGS. 4 and 5 are diagrams illustrating examples of data communication with an energy direction engine, in accordance with two embodiments;

FIG. 6 is an illustrative plot of predictive model of energy use, in accordance with one embodiment;

FIG. 7 is a schematic of an exemplary network approach for determining an optimised energy allocation plan, in accordance with one embodiment;

FIG. 8 is a schematic of an exemplary decision tree approach for real-time execution of an optimised energy allocation plan, in accordance with one embodiment;

FIGS. 9 to 19 are diagrams illustrating examples of data communication with an energy direction engine for various tasks, in accordance with various embodiments;

FIGS. 20 and 21 are a schematics illustrating exemplary energy direction systems or processes, in accordance with various embodiments;

FIGS. 22A to 22B are a schematics illustrating various exemplary data inputs and outputs with respect to energy direction for a facility, in accordance with various embodiments;

FIG. 23 is a schematic illustrating energy direction for facility and electric vehicle assets, in accordance with various embodiments; and

FIG. 24 is an exemplary graphical user interfacing illustrating various aspects of energy direction for a facility, in accordance with various embodiments.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

Unless defined otherwise, all technical and scientific terms used herein have the same meaning as commonly understood by one of ordinary skill in the art to which this invention belongs.

Throughout the specification and claims, the following terms take the meanings explicitly associated herein, unless the context clearly dictates otherwise. The phrase “in one of the embodiments” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The term “comprising” as used herein will be understood to mean that the list following is non-exhaustive and may or may not include any other additional suitable items, for example one or more further feature(s), component(s) and/or element(s) as appropriate.

The systems and methods described herein provide, in accordance with different embodiments, different examples of systems and methods for charging an electric vehicle (EV), or a fleet of electric vehicles, in the context of an energy management system that manages vehicle and non-vehicle loads within a location or geographic zone.

Some of the exemplary embodiments for fleet charging and energy management described herein, among other aspects, address a complex optimisation challenge of operational, financial, and logistical needs. Moreover, some embodiments herein described may do so while also monitoring energy across diverse needs and across different applications.

Historically presenting a challenge for conventional energy management systems, energy needs are diverse across applications, and often range from predictable and/or static to highly dynamic over time, depending on various factors. At least in part due to this challenge, and the complexity of optimizing systems or processes in view of financial, logistical, and operational requirements, conventional approaches typically address different energy needs separately. That is, while an energy management system may consider improved solutions for, for instance, electric vehicle (EV) charging schedules, such systems may not consider other building, facility, or zone energy needs, or vice versa.

For example, with respect to a facility or zone having energy needs related to aspects of both conventional infrastructure (e.g. energy assets related to utilities, appliances, equipment operation, and the like) and the charging of one or more electric vehicles via a charging station(s), each aspect is considered and managed within respective siloes, if at all. This may result in inefficient overall management of all energy resources through, for instance, poor scheduling and energy distribution among energy assets. This can negatively impact both the facility directly (or an organisation(s) associated therewith), as well as users of the grid, as suboptimal energy usage within a large facility may give rise to, for instance, demand penalties during peak hours, as well as pose risks to the power grid and/or affect pricing and availability for other users.

Typically, though not necessarily, energy needs with respect to building or facility management are predictable, and/or may relate to aspects of ‘static load analysis’, due to relatively consistent and controllable day-to-day operational factors. That is, such conventional infrastructure or like facility needs may have little or consistent variation, and may therefore be more predictable, in comparison to ‘dynamic’ loads characterised by higher volatility arising from external conditions that must be accommodated. This may in turn allow for reduced costs of asset use and/or increased comfort for users, and can generally be controlled inside a building environment.

Generally, such energy needs may be referred to herein as relating to a ‘facility’ or ‘facility operation’, although it will be appreciated that term ‘facility’ may be understood as referring to a geographical zone, a plurality of facilities or buildings, or a portion(s) thereof. Accordingly, terms such as ‘facility operation energy data’, or energy assets associated with a facility, or portion thereof, will be generally understood to refer to energy needs that do not necessarily relate directly to the charging of the batteries of electric vehicles based on, for instance, a predicted usage or charging schedule associated therewith. Examples of facility operation energy needs may relate to, without limitation, energy assets associated with heating and cooling (e.g. HVAC), other utilities, lighting, operation of facility equipment, servers or other computations resources, or the like. In accordance with various embodiments, such facility operational energy needs may be generally predictable and/or consistent over time periods (over the course of a day, a week, or the like), although they need not be within the context of facility energy needs. For example, energy assets related to the operation of specific equipment may predictably consume a given amount of energy at necessary and consistent times during operational days. Conversely, other energy assets, such as HVAC systems, while generally requiring a predictable total amount of energy over a designated time period (e.g. a day or week) in view of, for instance, weather and/or weather forecasts, may be operated in accordance with a relatively flexible schedule (e.g. scheduling operational times for off-peak time periods by advancing or delaying an operational period of heating or cooling), and thus may have energy needs associated therewith distributed in accordance with a more flexible schedule, despite corresponding with facility operation needs as considered herein, which generally are more predictable. It will be appreciated that in some cases, energy assets associated with a facility may also be related to the charging of electric vehicles, such as predictable and/or baseline energy requirements for the operation of charging stations that are not necessarily associated with an optimised charging regime based on a specific need (e.g. driving route for the following day, an imminently required charge based on a newly placed order, or the like), although such aspects may similarly be considered as relating to energy needs associated with vehicle operation or charging, depending on the context or application at hand.

Conversely, electric vehicle (EV) charging needs, and particularly the needs associated with the charging of a fleet of EVs, may relate to more variable, unpredictable, or dynamic day-to-day energy load needs due to the high number of variables arising from external influences. For example, fleet needs may be driven by external factors that may influence vehicle operational requirements, such as traffic conditions or cross-geography weather conditions that may vary and are not controlled by a building owner. This may result in highly dynamic energy needs as operational requirements vary, wherein needs are driven by external parties, in order to, for instance, move merchandise via a fleet of EVs, which may impact fleet use and operational costs. Various other energy needs that may be affected by operational requirements may further be considered, such as the dynamic and/or variable needs associated with EV use as a vehicle type, the effects of cargo weight on battery usage and corresponding charging needs, driver behaviour, which may optionally be considered in accordance with a particular driver or available driving staff, and may include aspects such as driving speed, energy use tied to vehicles based on driving habit information related to each driver or vehicle, or the like.

Generally, such energy needs may be referred to herein as ‘vehicle operational requirements’ and/or ‘charging energy requirements’. In accordance with various embodiments, such charging energy requirements may generally be influenced by vehicle operational requirements over a designated time period (e.g. an hour, a day, a week, or the like), which may be generally variable day-to-day as, for instance, delivery volumes, routes, and schedules are established or updated, and/or as driver and/or vehicle data is acquired and processed to update or improve estimates of operational requirements. Depending on the application at hand, such vehicle operational requirements may similarly relate to factors that change or evolve over time. For example, and in accordance with some embodiments, vehicle operational requirements may relate to unexpected or unscheduled events, such as abnormal traffic patterns (e.g. slow traffic conditions arising from an accident), unexpected weather events, urgent shipping or delivery needs, or the like. Accordingly, while various embodiments relate to the consideration of day-to-day vehicle operational requirements that may be scheduled and/or expected, various embodiments may additionally or alternatively relate to the consideration immediate and/or same-day requirements that may arise unexpectedly.

In view of, for example, the disparate nature of energy considerations noted above, the application of an energy management approach optimised for one of facility or vehicle energy needs will not result in an optimal solution for the other, or an optimal solution for a facility as a whole. Accordingly, an approach is needed that considers both types energy needs to, for instance, provide an optimal or improved recommendation or strategy for energy use based on overall user needs.

At least in part to this end, various embodiments herein described relate to the provision of systems and methods for managing energy usage for a facility comprising one or more charging stations for charging an electric vehicle, or a fleet thereof. It will be appreciated that as, as herein described, a fleet may refer to one or more electric vehicles generally associated with a facility or organisation. For example, a fleet of EVs may relate to a plurality of EVs associated with a delivery, shipping, or transportation company, to name a few examples. In some contexts, a fleet of EVs may relate to one or more electric vehicles associated with a living space, such as a condominium, strata, or apartment building. Other contexts for managing energy with respect to a facility associated with, for example, charging responsibilities with respect to one or more electric vehicles may similarly be considered with respect to various embodiments herein described.

Further, various embodiments relate to a digital ecosystem in which a variety of energy-related sources, which may traditionally be isolated from one another, may contribute data for receipt as input into a digital platform for managing energy-related processes in view of a broader scope of energy needs than is accessible with existing approaches to energy management.

Generally, embodiments relate to the provision and/or use of an optimisation engine that may receive has input data related to energy consumption management over a designated time period. An optimisation engine may, via one or more digital data processors associated therewith and based at least in part on such energy consumption management data, compute an energy distribution regime over the designated time period in consideration of an energy management condition (e.g. minimising energy costs, optimising as energy usage in consideration of a designated or prioritised vehicle charging and energy asset usage schedule, not exceeding a designated usage amount over a designated time period, balancing an energy supply and an energy demand, or the like). Various embodiments further relate to the provision of an operational direction corresponding to the computed energy distribution regime or energy distribution instructions, for example through the provision to a user via a graphical user interface (GUI) a report descriptive of the designated or prescribed energy distribution regime, or the direct or user-selectable operation of one or more energy assets and/or charging stations in accordance with the energy distribution regime.

In such contexts, energy consumption management data, in associated with a designated time period under consideration, may comprise, without limitation, energy supply data representative of energy supply characteristics, facility operation data representative of energy usage requirements by one or more energy assets, vehicle operation data representative of electric vehicle operational requirements, and charging data representative of a charging energy requirement associated with the one or more charging stations based at least in part on vehicle operational requirements. As described above, facility operation data may correspond with, for example and without limitation, infrastructure and/or facility personnel energy requirements (e.g. energy loads, volumes, schedules or times associated therewith, or the like) related to facility operation, such as heating and cooling systems, equipment, computing resources, and the like, and/or other requirements that may generally be predictable, consistent, and/or related to facility needs that may not be directly related to, for instance, electric vehicle charging requirements based on, for example, the operational requirements of EVs.

Such vehicle operational requirements, as described above, may relate to, for example, the amount of charge required for a fleet of EVs to, for example, meet the demands of a delivery schedule, or the demands of another application wherein one or more EVs may be of operation outside of a facility with charging infrastructure. Such requirements may accordingly encompass or otherwise relate to charging schedules, recharging schedules, energy consumption amounts, and the like, and may further consider, for example and in accordance with various embodiments, charge surpluses associated with a battery or batteries within a fleet in view of predicted operational requirements. Accordingly, charging data representative of a charging energy requirement may relate to, for example, the amount of energy required and the timing associated therewith in consideration of an existing battery charge, or surplus of charge above a particular requirement, to supplement or reduce the amount of energy required, for example, for facility energy assets and/or fleet charging. It will be appreciated that, with respect to vehicle operational requirements, various embodiments may consider requirements relate to unexpected usage requirements. For example, various embodiments relate to the consideration that one or more EVs may have unexpected needs and/or requirements that are not scheduled in advance of a designated time period (e.g. the day before a given operational day for which energy distribution is being calculated), such as the use by a resident of an EV associated with a condominium to run unscheduled errands, the use of an EV by a construction foreman travel to various job sites, or the like. Accordingly, various embodiments may account for unscheduled use in computations related to energy distribution instructions via the inclusion of a buffer amount of battery charge, a standard deviation or like metric of variation associated with historical usage, or the like, depending on the particular application at hand. In some embodiments, this may relate to the input of same-day operational requirements as needs arise, wherein a digital platform or method may consider such input and make same-day adjustments to energy distribution instructions.

It will be appreciated that the term ‘optimisation engine’, as referred to herein, may perform computations to determine an energy management solution that is not necessarily ‘optimal’ in accordance with the meaning of corresponding with a global or absolute maximum or minimum of a particular parameter, although such a meaning may be appropriate for some embodiments. Further, while various embodiments may be described herein with reference to an ‘EV engine’ or ‘EV optimisation engine’, it will be appreciated that such engines may additionally relate to the optimisation of energy usage with respect to energy assets associated with the facility comprising one or more EV charging stations.

In some embodiments, an optimisation engine may compute an energy distribution regime that, for instance, provides an improvement to a predefined or expected regime. For example, an optimisation engine may consider an energy usage profile observed and/or designated for a particular day for both facility operational requirements and EV fleet charging. The optimisation engine may further consider fleet operational energy requirements for a subsequent day, which may be different than the previous day, in view of, for example, weather or increased fleet operational energy usage (e.g. increased deliveries, longer routes, or the like). The optimisation engine may then compute, for example, that an energy cost savings may be achieved through the operation of a particular resource or energy asset (e.g. facility HVAC) at a different time in comparison to the energy usage profile previously observed/maintained, based on a high-priority fleet charging requirement. The optimisation engine may then report such a result or suggestion to a user, for instance via a GUI, and/or directly implement the improved regime (e.g. through control of a charging and/or facility resource) to achieve the predicted energy cost savings, or other benefit.

While this exemplary context relates to a computation of an energy distribution regime to achieve a cost savings, it will be appreciated that various embodiments may additionally or alternatively relate to the computation of an energy regime in accordance with another designated energy management condition. For example, and without limitation, a system or method as herein described may relate to the receipt or input of data related to a various operational parameters that relate to a prioritisation of facility and/or fleet operations. An energy management condition may thus relate to a time range over which certain operations may be permitted (e.g. the timing of charging two particular EVs given a delivery schedule), as well as, for example, a heating requirement for the facility with a designated minimum permissible temperature. The optimisation engine may compute an energy distribution regime that accommodates the relative priorities of energy use with respect to charging both EVs within their respective designated time ranges, and maintaining the minimum facility temperature, in view of energy costs. As a result, an output may relate to, for instance, the use of energy for all purposes simultaneously, despite high costs associated therewith, if, for instance, each energy need has an inflexibly or sufficiently high priority relate to an energy cost. Alternatively, the engine may prioritise the charging of one EV over the other at a given time based on that EV's operational needs, while simultaneously operating the facility's HVAC system but deferring charging of the other EV, based on the recognition of particular respective energy usage priorities. In accordance with some embodiments, such priority data may relate to input for receipt by an optimisation engine or processor associated therewith.

In some embodiments, such prioritisation may similarly consider any surplus energy in EV batteries that may be exploited to operate one or more assets. For example, a designated energy management condition may relate to the minimisation of energy use from the grid during a peak energy use time, with a low priority associated with the operations of a particular EV within the fleet. The engine may thus determine that battery energy associated with the low-priority EV be directed towards operating a different energy asset in the facility, or to subsidise charging of another EV, thereby minimising energy use from the grid.

Various embodiments may thus relate to the provision of energy distribution instructions that consider such a management condition. For example, various embodiments relate to the provision of charging instructions for one or more charge stations satisfying said vehicle operational requirements in view of an energy management condition. For instance, evaluation of a battery charge surplus in view of expected usage (e.g. delivery schedules for the EV, historical driving patterns associated with one or more EVs managed by a condominium complex on a designated day of the week, or the like) may result in charging instructions that draw on excess battery charge to operate a facility asset. Conversely, and in accordance with some embodiments, such charging instructions may relate to the charging of an EV battery at a designated time and to a designated charge level based at least in part to energy costs in view of operational needs. With respect to facility needs, energy distribution instructions may relate to facility operation instructions for energy assets associated with the facility which consider, for example, EV charging needs and energy supply characteristics (e.g. costs, availability, and/or the like). This may relate to, as noted above, instructions to draw on EV battery charge, for instance during peak energy cost times when there is available excess EV battery charge, or instructions to operate directly from the grid but in accordance with a schedule and power use that is defined in accordance with energy supply data and one or more conditions associated therewith.

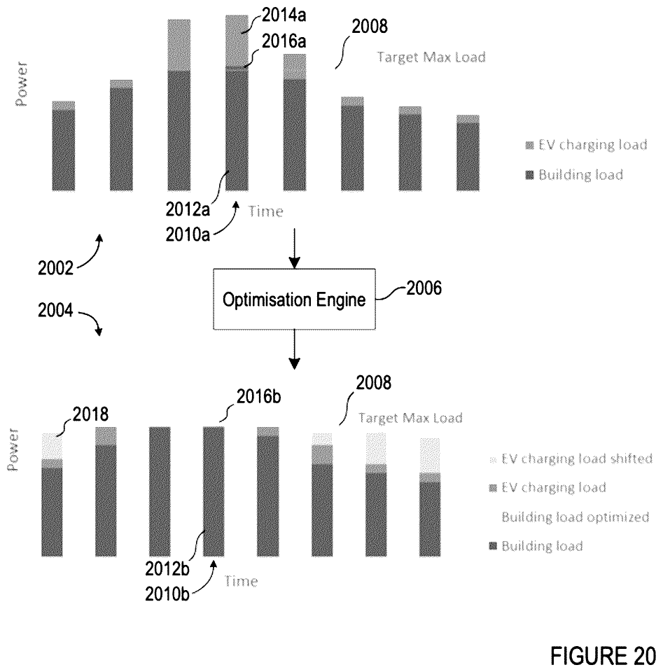

In accordance with various embodiments, FIG. 20 schematically illustrates various aspects of the systems and methods herein described. In this non-limiting example, FIG. 20 shows exemplary graphs of illustrative energy use over a designated time period before 2002 and after 2004 energy optimisation with an optimisation engine 2006. In the graph of energy use 2002 before optimisation, total power use exceeds designated energy management parameter 2008 over several time intervals, in this case corresponding to a target max load 2008. Such a parameter may relate to, for example, a total usage limit for a given time interval above which additional energy fees are charged to the user. Accordingly, power usage totals for the time intervals exceeding the target 2008 (e.g. during peak energy use times) incur additional costs, even if the total power usage over the designated time period of graph 2002 does not exceed a maximum power threshold for the entire time period. In this non-limiting example, the designated energy management parameter 2008 corresponds to a constant value throughout the designated time period for simplicity, although it will be appreciated that such a parameter may vary, for instance in accordance with peak or off-peak hours through a day, week, or other time interval.

In the exemplary graph 2002 of FIG. 20, power usage bars relate to energy usage of both facility and EV operation. As is apparent from the exemplary graph 2002, consideration of EV charging needs in addition to facility usage results in several time intervals throughout the designated time period (e.g. the day) that incur additional costs above the raw usage totals by surpassing the target 2008. Moreover, in the illustrated example, the time interval 2010a comprises power usage for energy assets of the facility 2012a that alone exceeds the target 2008, wherein, even without consideration of EV charging 2014a, the facility would be charged overage fees for the portion 2016a of power used during the time period 2010a.

In accordance with various embodiments, an energy optimisation engine 2006 may determine an energy distribution regime that may improve upon, for instance, the energy costs associated with facility and EV energy management over a designated time period. For example, the energy optimisation engine 2006 may receive as input data related to various aspects of energy management, and output a more cost effective or otherwise designated energy use and/or distribution regime, a non-limiting example of which is shown in the graph 2004 of FIG. 20. This may relate to, for instance, the engine 2006 receiving as input energy use profiles expected based on observed or predicted usage, which may relate to, for illustrative purposes, the power use profile of graph 2002 of FIG. 20. The optimisation engine 2006 may then compute therefrom a redistribution or other mitigating means of redirecting energy resources over the designated time period. For example, the designated time interval 2010b, which under the uncorrected regime of graph 2002 resulted in overage charges, has reduced energy needs with respect to the corresponding usage 2012a and 2014b of graph 2002.

The means by which energy is redistributed or reduced may vary, in accordance with various embodiments, based on, for instance, the application and/or resources at hand. For example, in the schematic of FIG. 20, the optimisation engine 2006 shifts EV charging loads (e.g. EV charging load 2014a) to different time intervals by introducing EV charging to other time intervals. For instance, a portion of the EV charging load 2014a may be shifted to the shifted EV charging load 2018 in the interval corresponding to the left-most bar of graph 2004, in which substantially more energy may have been used before surpassing the target 2008 in graph 2002.

On the other hand, the optimisation engine 2006 further optimised energy use with respect to energy assets of the facility. For instance, the facility energy use 2012a, which exceeded the target 2008 by the usage amount 2016a, is reduced by the optimisation engine 2006 to the building load use 2012b in graph 2004 of optimised use. In this example the previously excess energy use 2016b relates to an amount of energy that was eliminated by the optimisation engine 2006 through an improvement of facility efficiency, resulting in an energy use 2012b that does not exceed the target 2008. This may be achieved, for example and in accordance with various embodiments, by reducing or eliminating the operation of one or more energy assets in the facility, for instance in accordance with a priority metric, wherein non-essential or low-priority assets may be identified by the engine 2006, and its operation more efficiently managed. Additionally, or alternatively, such a reduction in facility energy usage 2016b may be achieved via, for instance, the supply of energy from an alternative source, such as an EV battery having charge in excess of what is required over, for instance, the designated time period, and/or in view of operational requirements for that EV and/or battery.

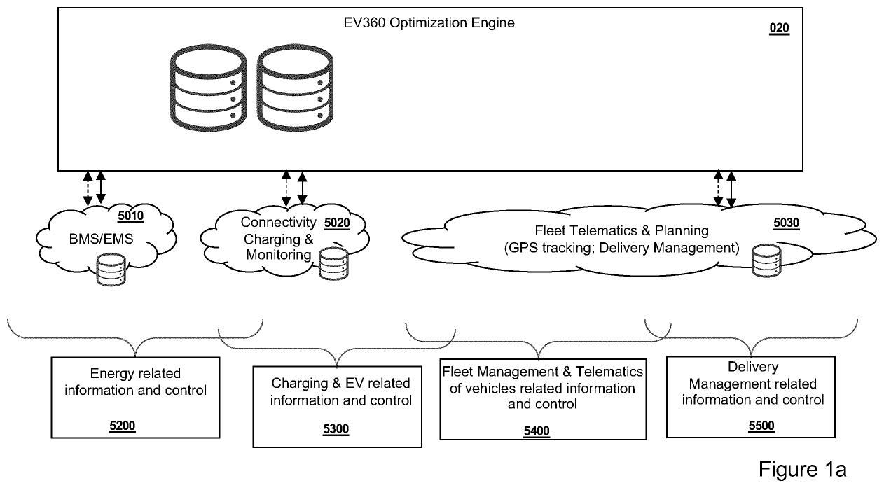

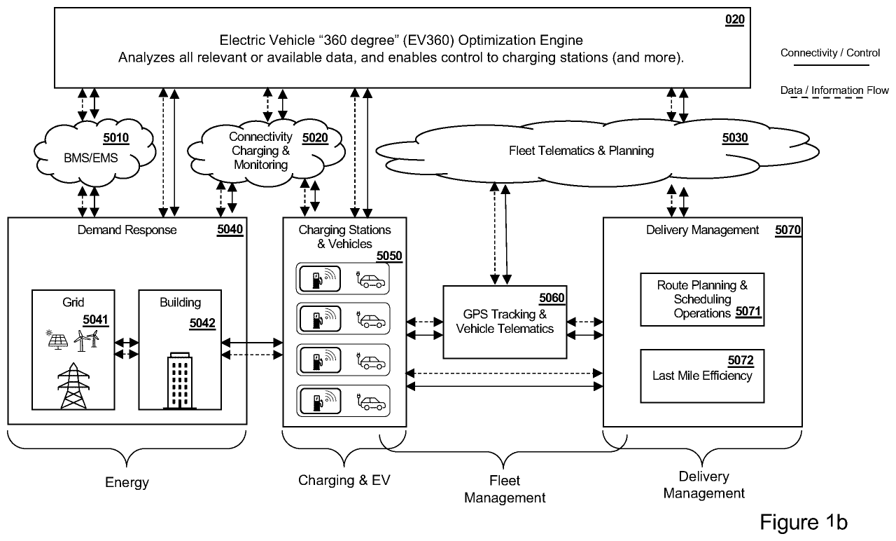

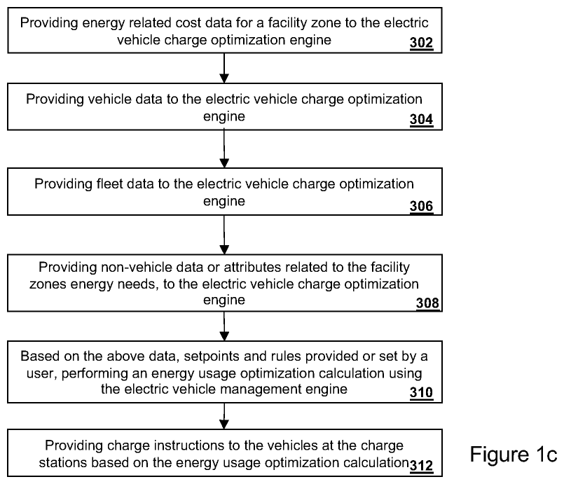

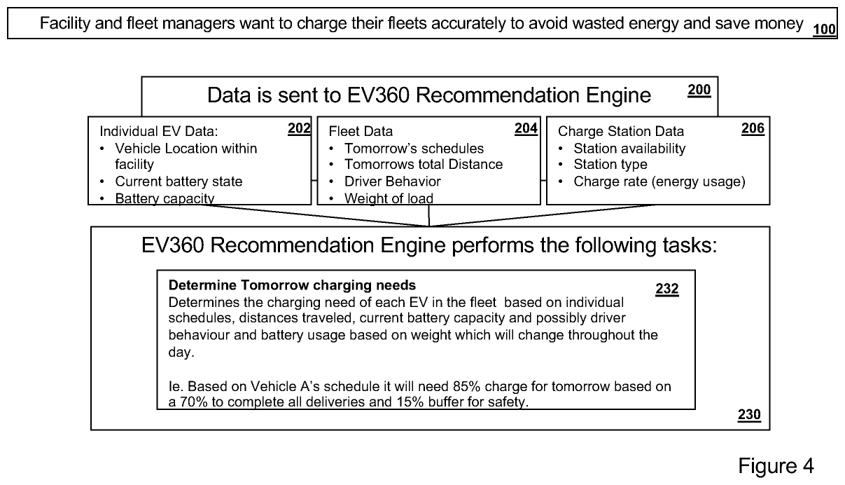

Accordingly, in the non-limiting example of FIG. 20, the optimisation engine 2006 effectively reduced energy costs for the facility by, for instance, redistributing EV charging loads to off-peak time intervals, and optimising operation of energy assets of the facility, eliminating energy use above a maximum target load 2008. It will be appreciated that an optimisation engine may, in accordance with other embodiments, consider additional or alternative data sources, and/or employ alternative management conditions with respect to energy distribution. For example, various aspects of energy distribution management described with respect to FIG. 20 and the optimisation 2006 may be similarly applied in other contexts, non-limiting examples of which may include the optimisation engine 020 described below with respect to FIGS. 1a and 1b, and vice versa. For example, the optimisation engine 2006 may be configured depending on the application or use case at hand, non-limiting examples of which are described below with respect to, for example, FIGS. 4, 5, and 9 to 19.

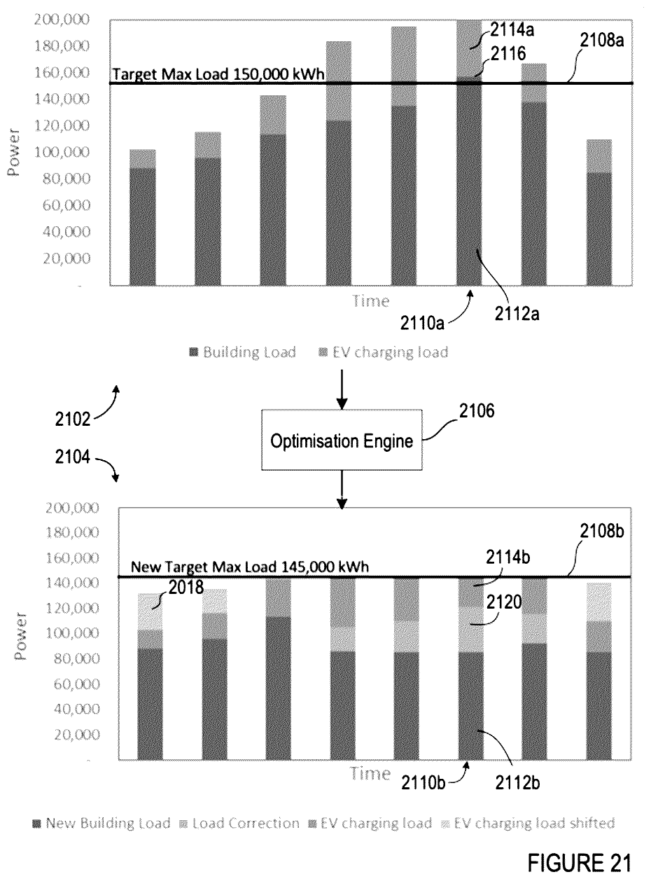

FIG. 21 schematically illustrates the operation of a similar system or method, in accordance with various embodiments. In this non-limiting example, an optimisation engine 2106 considers predicted power usage 2102 for a facility, including both building load (e.g. the operation of energy assets of a facility) and EV charging loads (e.g. the amount of energy expected to be required to charge a fleet of EVs) over a designated period (e.g. over the course of an operational day). In this case, the optimisation engine 2106 digitally directs operation of EV charging stations and energy assets of the facility to improve management thereof by calculating a designated energy distribution regime 2104.

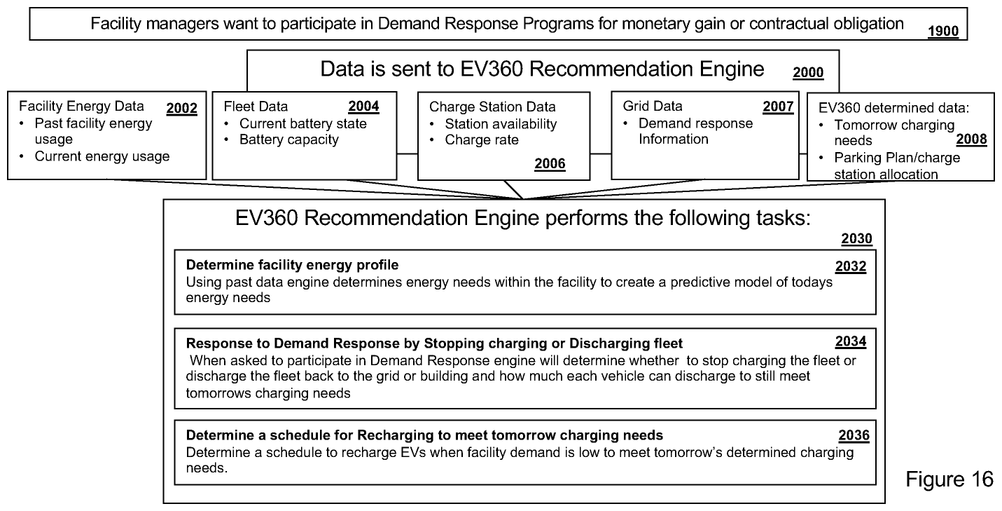

Similar to the example of FIG. 20, the distribution of power over the time period 2102 is expected to surpass a designated max target load 2108a, resulting in, for example, overuse charges for some time intervals. Such a limit 2108a may relate to, for example, a demand response limit, as further described below with reference to grid data 2007 of FIG. 16, and/or may generally relate to an amount of energy or power having related thereto a demand penalty, such as those that are charged by a utility organisation based on, for instance, historical 5-minute, 15-minute, 30-minute, or like demand calculations. Accordingly, various embodiments relate to, among other aspects, the mitigation of demand penalties with respect to energy use by a facility.

In the example of FIG. 21, the time interval 2110a is expected to produce loads exceeding the target 2108a due to the facility needs 2112a alone, wherein the facility needs exceed the target by predicted amount 2116. The optimisation engine 2106 may thus calculate, similar to the example of FIG. 20, a redistribution of EV charging times, wherein, for example, a portion of the EV charging load 2114a is shifted to one or more other time intervals. For instance, the left-most time interval in FIG. 21 comprises a shifted EV charging load 2018 which may correspond to the EV charging load of one or more of the charging loads corresponding with time intervals in which power usage overages were expected. However, it will be appreciated that, in accordance with some embodiments, a shifted EV charging load (e.g. load 2018) may correspond not only to charging loads from intervals in which overages were expected, but may additionally or alternatively correspond to charging loads from other time intervals, as determined by the optimisation engine 2016. For example, based on the operational needs (e.g. schedules, routes, return-to-facility times, or the like) of one or more EVs, it may be decided that charging loads for some EVs expected to occur during off-peak hours may be similarly be shifted due to the logistics of charging other EVs during peak hours, wherein the scheduling of several EV charging loads is adjusted to accommodate one or more energy optimisation conditions and/or designated energy management conditions (e.g. reducing energy costs).

In the example of FIG. 21, and in accordance with various embodiments, the designated energy management regime 2104 relates to a maximum target load 2108b that is distinct from the maximum target load 2108a. That is, while the example of FIG. 20 related to a redistribution and optimisation of energy loads to reduce interval energy usage to the target max load 2008, the example of FIG. 21 relates to further optimisation of energy use over the designated time period so to further reduce energy use over each interval to a target maximum load 2108b than is lower than the target maximum load 2108a shown before optimisation (e.g. a maximum load above which a fee may be incurred, or the like). This may be beneficial to, for instance, provide a buffer of energy use to allow for unexpected energy use within an interval without incurring overage fees, to generally reduce overall energy use throughout a time period, or the like.

In addition to improving efficiency of energy use, as described above with respect to FIG. 20, the optimisation of energy management of FIG. 21 further relates to the provision of load corrections to reduce energy use within a particular interval. For example, the interval 2110b corresponds to a reduced facility usage 2112b as compared to the expected usage 2112a, arising as a result of both reduction of energy use during that interval, and of a load correction 2120, as determined by the optimisation engine 2016. As a result of this reduction in facility energy asset use 2112b and load correction 2120, the time interval may further relate to charging of EVs 2114b before the new target maximum load 2108b is reached, thereby providing, for instance, additional flexibility in accommodating EV charging based on operational needs (e.g. EV charging is not necessarily limited to off-peak hours). Accordingly, some of the embodiments herein described relate to the reduction of peak demand energy use. That is, various embodiments relate to the mitigation of energy use such that the amount of energy consumed by a facility within a time interval (e.g. 5-minute, 15-minute, 30-minute, or similar time interval determined or set by a utility provider), which may incur a cost penalty if surpassing a peak target value, is reduced to avoid additional utility costs.

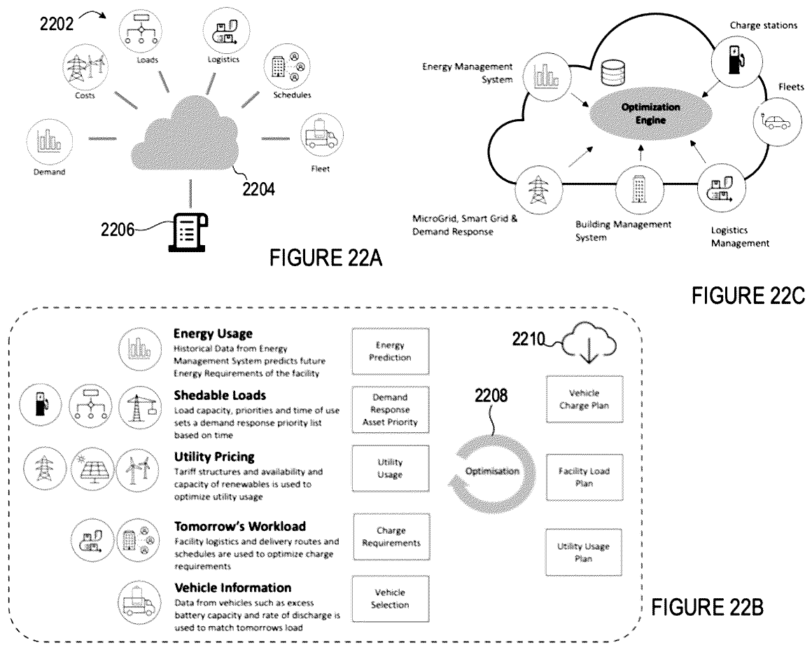

In accordance with various embodiments, various of the systems and methods herein described may provide for the management of energy use of a facility through the consideration of various data sources related to energy use and/or additional factors received as input. For, example, FIG. 22A schematically illustrates how various embodiments relate to the receipt of data 2202 via a digital interface 2204, whereby calculations are performed to determine a designated energy distribution regime 2206, which may be, for example, digitally reported to a user to direct operation of energy assets and/or charging stations.

In accordance with some embodiments, energy management data may relate to the input of data 2202 related to energy demand, costs, and loads, as well as various logistic, scheduling fleet parameters. Such data is may be generally accessed in accordance with various methods and/or by various systems, for instance via accessing of a cloud-based digital platform 2204 to which is reported data related parameters relevant to a particular application, although it will be appreciated that other digital interfaces may be employed, in accordance with different embodiments. For example, a facility may comprise various sensors to monitor energy use, and/or a facility may comprise one or more digital input devices to receive data related to energy usage and/or any operational parameters of interest, wherein a system or method may receive such data as input to perform one or more calculations. Accordingly, while, for simplicity, the following description relates to the receipt as input at an optimisation engine and/or one or more digital data processors energy management data from a cloud-based digital platform 2204, such as a cloud-based data repository(ies) having data uploaded thereto, for instance via digital wireless reporting of fleet data from the fleet itself or EVs thereof, various embodiments may additionally or alternatively relate to other means of receiving data as input.

FIGS. 22B and 22C schematically illustrate additional exemplary aspects of data that may be received as input for an optimisation process 2208, wherein data is received as input in or from a cloud-based environment 2210. In this example, optimisation 2208 is performed in accordance with various aspects related to data received as input, such as, and without limitation, predictions with respect to energy usage and/or or requirements, energy demand, response, and asset priorities, facility utilities, EV charge requirements, vehicle selection, vehicle charge plan(s), facility load plan(s), and utility usage plan(s). Such optimisation may further be performed in the context of an environment or ecosystem in which data from a plethora of data sources, non-limiting examples of which are schematically illustrated in FIG. 22C and which may traditionally be considered independently, serve as input for optimisation.

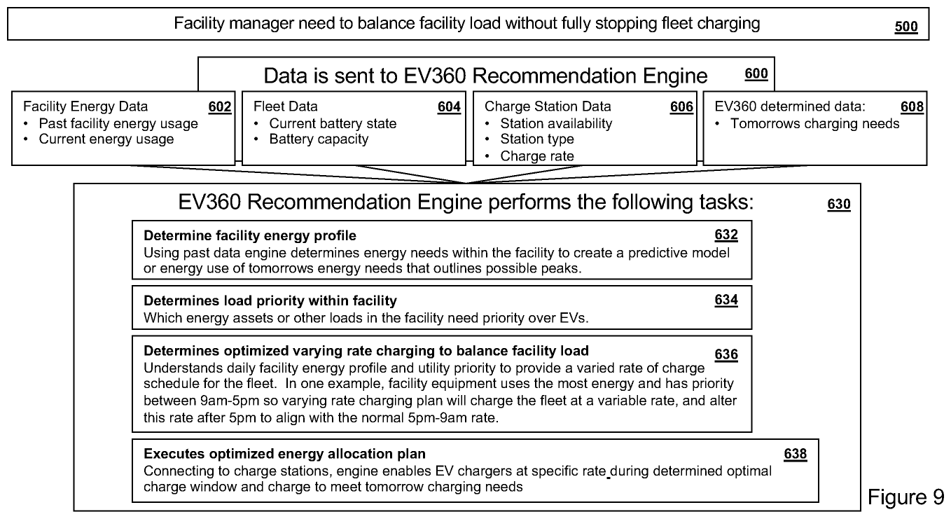

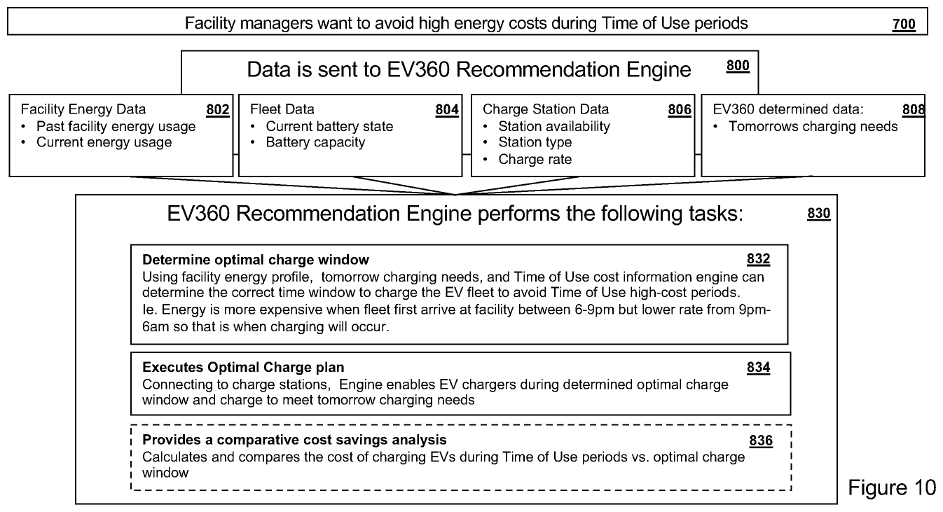

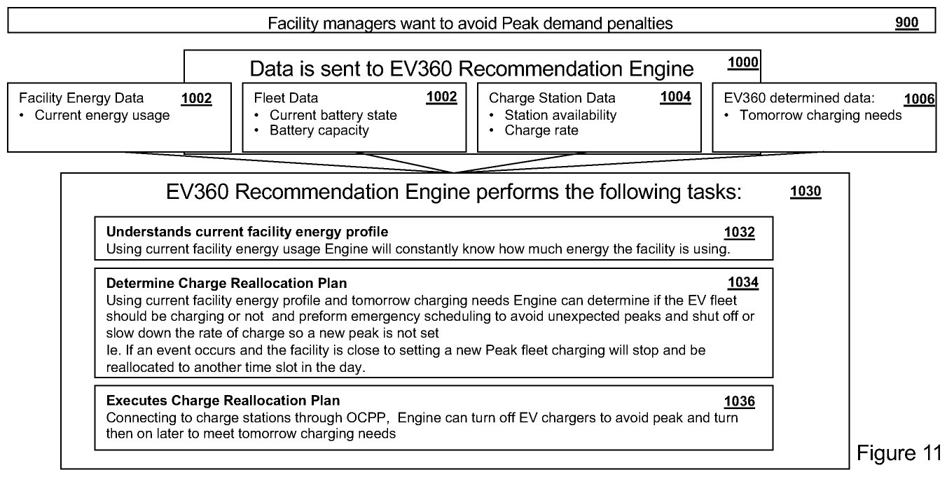

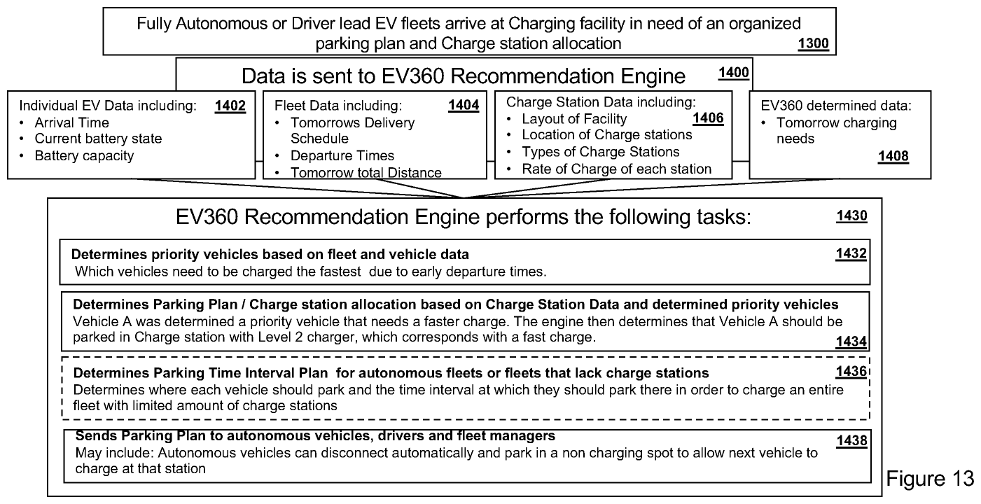

Such optimisation 2208 may yield, for example, various suggestions with respect to any one or more aspects of interest, such as the provision of an EV charging plan (e.g. amounts of charge and scheduling thereof), adjustments to an expected utility usage plan, selection of vehicles for particular operational tasks, reduction and/or optimisation of energy usage, or the like. It will be appreciated that various optimisation processes may be employed, depending on the particular application at hand and/or any energy management conditions that may be of interest, such as total costs for facility and EV operation, meeting any operational or logistical demands based on, for instance, priority levels associated therewith, or the like. Accordingly, FIGS. 22A to 22C schematically illustrate a high-level overview of various data sources that may be considered as input for, and exemplary outputs from, an optimisation engine as herein described. Various additional aspects of such and similar embodiments are further described below with respect to, for example, FIGS. 1a and 1b, wherein an optimisation engine 020 considers various data sources to, among other aspects, manage 5070 various aspects of route planning and scheduling operations 5071 and Last Mile efficiency 5072. Similarly, FIGS. 4, 5, and 9 to 19 schematically illustrate various use cases for exemplary energy recommendation engines directing energy management in consideration of various data inputs and energy management conditions, such as, without limitation, balancing facility loads without stopping EV fleet charging (FIG. 9), avoiding high energy costs during time of use periods (FIG. 10), avoiding peak demand penalties (FIG. 11), and charge station allocation for an organised parking plan for a fleet of EVs at a charging facility (FIG. 13).

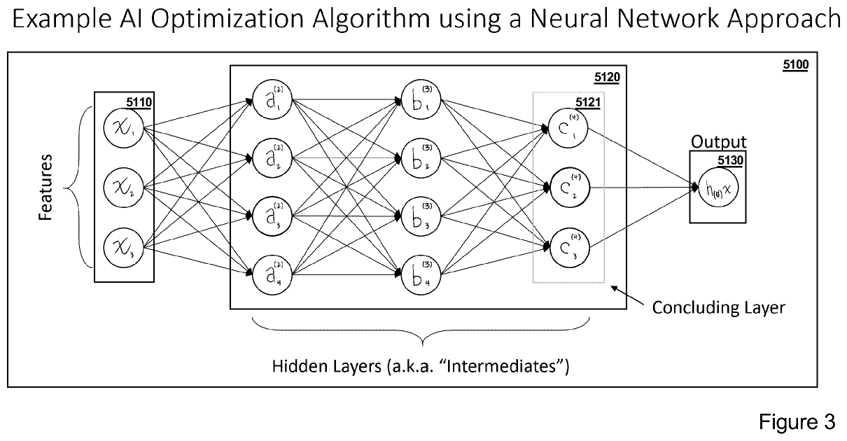

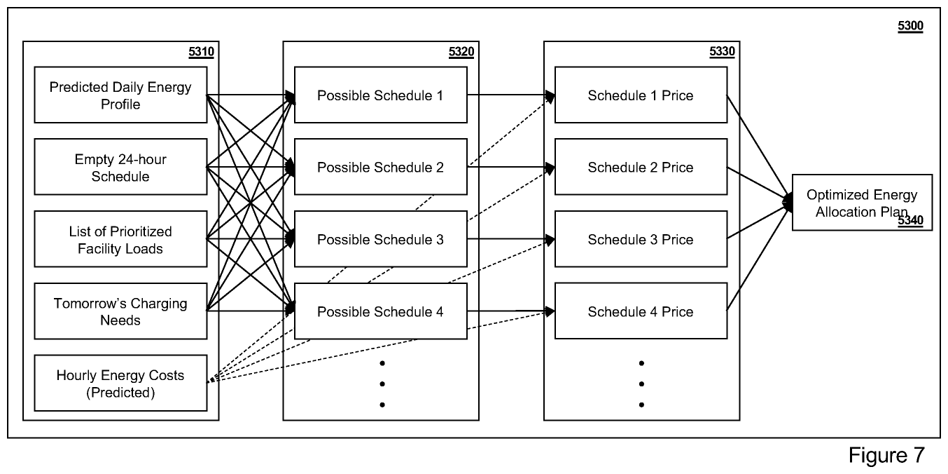

Generally, optimisation 2208 may relate, in accordance with some non-limiting embodiments, to an iterative process, whereby calculations are performed and iteratively improved. Additionally, or alternatively, other means known in the art for optimisation may be employed, the nature or which will be appreciated the skilled artisan. In accordance with some embodiments, optimisation and/or improvement of various energy management aspects, and/or generally the determination of an energy management regime, may relate to a machine learning and/or artificial intelligence process or system, as is schematically illustrated in FIG. 3. For example, historical data related to, for example, EV operational data (e.g. mileage, battery performance, and the like) may be reported automatically to a cloud-based energy management ecosystem 2204 or 2210, as well as facility energy use characteristics (e.g. historical or expected energy use characteristics for utilities and the like). Similarly, energy supply characteristics (e.g. hourly energy pricing, usage limitations and/or costs associated therewith, maximum amounts, and the like) may be automatically accessed and/or received, while further received as input are one or more designated management conditions (e.g. vehicle and/or other energy asset priorities). An optimisation engine 2208 may employ a machine learning or other optimisation process to determine optimal or otherwise beneficial energy schedules for a particular application, such as maximising savings while providing an optimum or beneficial efficiency and reliability. For example, FIG. 7 schematically illustrates one non-limiting example of an embodiment in which various considerations 5310 are received as input to generate a plurality of possible schedules 5320, wherein cost evaluations 5330 ultimately enable determination of an optimised energy allocation plan 5340.

Accordingly, various aspects relate to an energy management system or method that may combine data from various sources (e.g. facility- and EV-related) to create an optimised energy usage plan for an expected workload (e.g. the following day's predicted operations). As such, various embodiments provide for the reduction of overall costs via, for example, the elimination of demand and time of use energy penalties, resulting in cost savings to the user and increase of reliability and efficiency of both EV fleets and facility management. Furthermore, it will be appreciated that various embodiments may relate to the real-time monitoring of energy needs and operations, thereby providing such benefits in real-time as needs change or adapt based on operational requirements. In accordance with some embodiments, such benefits may extend beyond energy management, and may further include, without limitation, operational recommendations based on, for instance, time-of-use schedules with respect to energy needs. For example, various embodiments may additionally or alternatively relate to the scheduling not only of energy use with respect to expected needs, but may, for example, suggest or schedule one or more operations (e.g. fleet routes and times associated therewith) in consideration of energy demands and overall costs in consideration of energy assets in a facility.

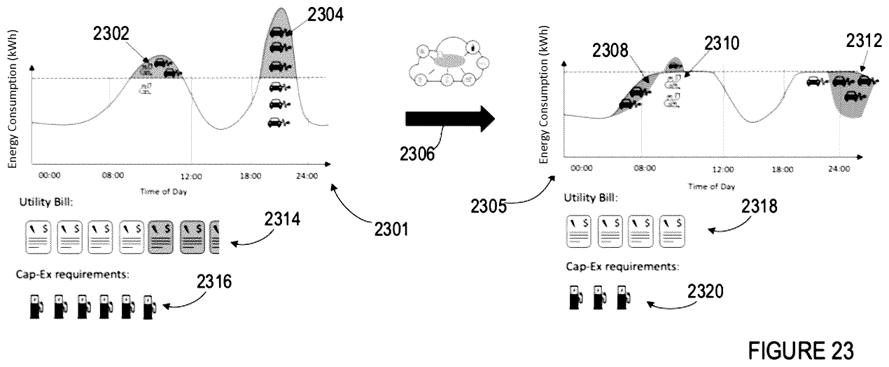

At least in part to these ends, FIG. 23 schematically illustrates how a system or method as herein described may provide for an energy management solution to, for instance, improve energy management for a facility comprising or more EV charging stations. In this example, a plot of expected energy consumption 2301 is shown over the course of a portion of an operational day for a facility, while an energy management regime 2305 determined by an optimisation engine 2306 as described herein is shown for the same designated period of time. In this example, the expected energy consumption 2301 reflects demand penalties from a combination of EV fleet charging (e.g. topping up the EV batteries of the fleet) and facility equipment use in the mid-morning 2302, as well as during a peak time 2304 between 18:00 and 24:00 arising from, for example, demand penalties related to EV fleet return and recharge after the day's operations. The optimised energy distribution regime 2305, on the other hand, relates to defining a pre-charge of EVs 2308 to avoid the projected peak 2302 in the midmorning, while reducing facility energy use 2310 through the use of stored EV capacity during the peak 2302, thereby avoiding the overage costs entirely. Similarly, the peak 2304 arising from recharging the fleet after the operational day is avoided by shifting 2312 the charging of (optionally specific) vehicles to later charge times. As schematically illustrated, such optimisation 2306 results in reduced costs via a reduced utility bill 2318 as compared to a pre-optimisation utility bill 2314, while also providing for reduced capital expenditures 2320 as compared to pre-optimisation 2316, as, in this non-limiting embodiment, optimisation of energy usage via the embodiment described provides for a reduction in the number of, for instance, charging stations required to charge a given number of EVs (i.e. fleet charging and scheduling is more efficient, reducing the need for extra charging stations, thus reducing the need to add more capital expenditure costs, such as those arising from the inclusion or establishment of additional charge stations, alternative energy sources and/or microgrids related to solar-based power generation, wind harvesters, generators, or the like, as well as costs associated with connection to a power source, such as the capital cost of adding power lines from a substation.

The exemplary embodiment of FIG. 23 is provided for illustrative purposes, and accordingly illustrates a high-level overview of the provision of energy distribution instructions via an optimisation process 2306, and it will be appreciated that various embodiments may relate to alternative or additional configurations in which various alternative data inputs are considered. For example, FIG. 1b schematically illustrates an exemplary connectivity of data sources and other aspects of a system or method as herein described, as well as exemplary data transfer within an energy management ecosystem. Such aspects may be analogous to aspects of, for example, the embodiments more generally described above with respect to FIGS. 22A to 22C and FIG. 23, wherein an optimisation engine 020 may perform one or more processes related to, for instance, optimisation 2306 or optimisation 2208, and vice versa.

In accordance with various embodiments, the systems and methods herein described may provide for energy management solutions in accordance with various outputs. For example, some embodiments relate to the recognition of various improvements and/or optimisations that may be realised with a designated energy management regime (such as those described above), and provide a digital control signal to implement the same to automatically realise predicted benefits (e.g. cost savings). For example, various system and methods relate to the automatic digital implementation of energy asset and charging station operation, for instance via a control management interface, wherein suggestions from a digital engine are used to control charging stations and facility assets directly.

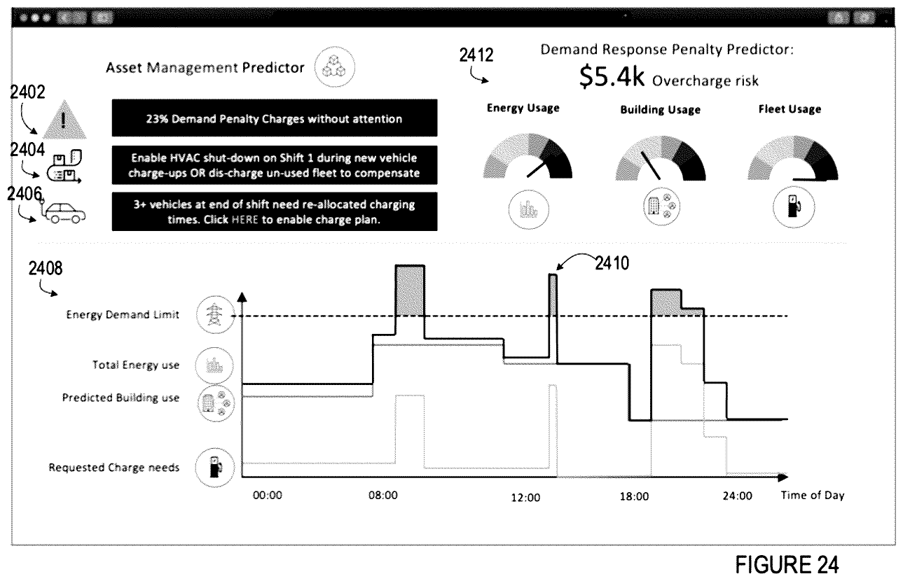

In accordance with some embodiments, a designated energy management regime, and/or suggestions related thereto, may be output to a user, such as a facility manager and/or fleet operator, for evaluation and/or implementation. For example, and in accordance with various embodiments, FIG. 24 is a schematic of an exemplary graphical user interface (GUI) via which a user may interact with an energy management system. In this example, the system, or a method executing the same, received as input energy management data and computed an energy management regime that addressed several deficiencies with respect to historical energy management in view of upcoming operational conditions. The system then digitally directs operation of assets in the facility (e.g. EV charging stations and/or other energy consumption assets in the facility) via the GUI for instance though the provision of indicators and/or controls that the user may review and/or select to realise the improved management of energy in associate with the facility.

As shown in the exemplary GUI of FIG. 24, an asset management predictor of the system may provide digital alerts to the user. For example, the GUI may provide the alert 2402 that, without attention, a demand penalty is expected for the following day without if no intervention in taken. Similarly presented to the user is the notification 2404 as to a potential solution to energy management that may reduce or mitigate any potential energy issues. In this example, the alert 2404 relates to the operation of facility asset, namely the HVAC system of the facility, which, in this case, is indicated in association with the provision of two suggestions that may mitigate the predicted overage (i.e. to shut down the facility asset at a certain time or discharge unused energy stored in EVs to mitigate energy use from the grid during EV charge-ups). Similarly, the GUI alerts 2406 the user as to the excess charge needed at the end of the shift, and thus suggests re-allocation of charging times for those EVs. As noted above, in this latter example, the alert 2406 is provided with the user-selectable option to enable the optimised charging plan via the GUI, wherein charging will automatically be digitally directed via the system upon user selection.

In accordance with various embodiments, the systems and methods herein described may further improve over conventional systems through the provision of a means for improved user understanding of the interaction between various needs of a facility, and therefore improved management of the same. For example, the exemplary GUI of FIG. 24 further describes the predicted energy used for the facility in an intuitive manner for the user's understanding, and therefore improved management. In this example, the GUI displays information 2408 related to the energy demand limit for the designated time period in question, as well as breaks down predicted total energy use by both the building or facility use and charge needs based on requests or otherwise scheduled needs. This may facilitate recognition of, for instance, peak charging risks 2410 based on fleet needs during critical facility operation times, and further inform management practices with regard to the same. Furthermore, the GUI may display information related to, for example, demand response penalties 2412, further allowing the user to understand and react to predicted energy costs based on different energy uses (e.g. facility operation and EV operation).

It will be appreciated that the exemplary GUI of FIG. 24 is provided for exemplary purposes, only, and that various embodiments may relate to alternative GUI configurations for, for example, receiving various forms of data as input, and/or generating alternative output related to energy distribution within a facility. For example, the exemplary GUI of FIG. 24 may be readily applied for use cases related to, for instance, FIG. 11, wherein an energy management system is employed to provide distribution instructions in accordance with a designated management condition 900 corresponding to avoiding peak demand penalties. However, various embodiments may similarly relate to a GUI configured for other use cases and/or designated management conditions, non-limiting examples of which are described below with respect to, for example, FIGS. 9, 10, and 12 to 19.

It will be appreciated that such embodiments may relate to a digital platform for managing energy use wherein various aspects of ‘intelligent’ systems may be employed, wherein, for instance, monitoring and/or operation of various assets may be performed in accordance with predefined schedules, and the like. Moreover, various aspects of, for instance, a GUI as described above, may operate in accordance with various digital protocols, such as internet- or cloud-based protocols, subscriptions, and/or in accordance with various digital licensing protocols known in the art. For example, and in accordance with some embodiments, various systems and methods as herein described may be configured in accordance with software-as-a-service specifications and/or protections, and may accordingly comprise various software, firmware, or hardware components related to the same.

In accordance with various embodiments, such systems and methods may provide improvements in energy management, as well as, for example, costs related thereto, for various users and applications. For example, building and EV fleet owners may be provided with a simplified means of optimising energy usage for their entire ecosystem (e.g. both EV fleet requirements as well as facility management). For example, an energy management platform as herein described may provide for the optimisation of data from multiple otherwise independent ecosystems to manage and control a wider energy usage footprint, as well as reducing capital expenditures via, for instance, more efficient use of resources. This may be beneficial, for instance, in the management of charge stations as an advanced charge and control system solution for fleet and building management. Similarly, an end user comprising an EV company may rely on embodiments as herein described to offer improved charging services. Similar benefits may be realised with respect to applications of, for example, fleet management, logistics management, and even the provision of energy itself (e.g. energy companies), as these and other applications man benefit from the embodiments herein described as a digital platform for balancing and managing broader energy needs than is possible with current systems.

Similarly, various embodiments as herein described may be configured to enable context-specific modules based on the application at hand. For example, a system, method, or computer-readable medium having digital instructions stored thereon for execution by a digital processor may be configured to address, for example, different energy management conditions, to provide digital direction of energy management addressing various telematics applications (e.g. navigation, tracking, mileage, energy recovery, charging status and history, battery level and/or health, integrated site energy management systems), corrective action with respect to time of use rates (e.g. the application of local utility time of use boundaries to non-critical loads to minimize higher rate charges), energy management with respect to the integration of charge stations (e.g. exposing charge station load to the site energy management system, synchronising building and fleet loads, creating a holistic historical usage profile to inform future energy consumption profiles, or the like), logistics management with respect to future workloads (e.g. delivering current production needs, JIT charge for future driving demands leveraging specific vehicle telematics and driver schedules, and the like), and/or dynamic load balancing with respect to demand charge avoidance (e.g. real-time load balancing, optimisation of available utility sources (grid, renewable & storage), utilisation of predictive load profiles, and the like).

For example, depending on the particular application at hand, various systems and methods may receive as input data related to one or more of various data sources, non-limiting examples of which are schematically illustrated in FIG. 22C, whereby an optimisation engine may further receive as input a context-specific designated energy management condition (e.g. related to telematics, time-of-use rates, energy management, workload, dynamic load balancing, charge stations, EV charging services for an EV organisation, fleet management, logistics management, energy management in the provision of energy, energy costs, or the like). An optimisation engine, having access to a digital environment in which any data required for computation may be received as input, may then compute a designated energy distribution profile, which may relate to, for example, scheduling of energy use or supply, amounts or time associated with energy for the charging EVs or other energy assets, or the like, and thus provide improved energy management within the particular context of interest.

It will be appreciated that various embodiments may relate to the provision of an optimisation engine that may provide various outputs, depending on the particular application at hand. For example, one embodiment relates to the provision of digital direction with respect to energy use as it relates to each of reporting a cost savings and reporting on environmental, social, and governance (ESG) criteria. An alternative embodiment relates to governance of energy as it pertains to ESG sustainability reporting, telematics, corrective action with respect to time of use rates, and the integration of charge systems within a digital platform. An alternative embodiment relates to governance of energy as it pertains to ESG sustainability reporting, telematics, corrective action with respect to time of use rates, the integration of charge systems within a digital platform, synchronisation with an expected future workload (e.g. the analysis and direction of tomorrow's energy use), and dynamic load balancing.

Alternatively, or additionally, various embodiments relate to the input of and output of various datasets or parameters AI-optimised energy distribution. For example, one embodiment relates to the provision of AI input corresponding to telematics, corrective action with respect to time of use rates, and parameters related to the integration of charge stations with a digital platform as herein described, and the AI output of data corresponding to mitigation instructions with respect to energy usage, and/or a report with respect to ESG sustainability reporting. In accordance with another embodiment, AI input may relate to data corresponding with telematics, corrective action with respect to time of use rates, parameters related to the integration of charge stations with a digital platform as herein described, and a future expected workload, and the AI output of data corresponding to mitigation instructions with respect to energy usage and dynamic load balancing, and/or a report with respect to ESG sustainability reporting.

In accordance with various embodiments, the systems and methods herein described may address a number of challenges associated with conventional systems, which remain siloed with respect to energy data consideration and usage optimisation. For example, various embodiments herein described relate to systems and methods, and more generally do digital platforms and environments, which consider both EV fleet and facility energy needs to address each of: ‘last mile’ delivery management, fleet management, vehicle telematics, charge station management and ‘smart charging’ functionality, vehicle energy management, facility energy management, electrical distribution, charge stations, and electric vehicles.

Such and additional examples are further described below with respect to FIGS. 1 to 19, which illustrate representative configurations and exemplary embodiments related to an energy management system, EV charging system, and/or optimisation system architecture, also referred to herein as an EV Optimisation Engine, or engine 020, which may work to enhance on-site energy consumption, prediction, and control features in conjunction with EV charging scheduling. It will be appreciated that components of the systems described herein are for illustrative purposes, only, and that other suitable components may be used in conjunction or as alternative to elements herein described to operate an EV Optimisation Engine 020, without departing from the general scope and nature of the disclosure. Similarly, it will be appreciated that such an optimisation engine may relate not solely to the management of energy within a geographic zone, facility, or portion thereof as it pertains to electric vehicles, but may similarly consider and/or manage energy usage with respect to a utility (e.g. heating, cooling, or the like), appliance(s), and/or other power needs, as described above. Further, while the description above with respect to FIGS. 20 to 24 is generally provided to broadly illustrate various aspects of the embodiments herein described, it will be appreciated that such description may be equally applied to the exemplary embodiments described below with respect to FIGS. 1 to 19, and vice versa.

In accordance with some exemplary embodiments, the engine 020 is configured to optimise the energy needs of an area (also referred to herein as a ‘zone’), such as a building, a facility or portion thereof, or a collection of buildings. At least in part to this end, various embodiments relate to the optimisation engine executing control instruction(s) to an energy device in the zone based on the optimised energy needs of the zone. In some embodiments, this is accomplished by monitoring energy data attributes for the zone, electric vehicle data attributes connected to a charge station in the zone, and at least one non-vehicle energy device in the zone. An energy use optimisation calculation may then be performed based on the monitored data and attributes, which may be used to then provide charge instructions for electric vehicles connected to the charge station based on the optimised energy needs of the zone. By accounting for the needs of the EV's planned use alongside broader energy needs, the cost of energy use (e.g. Time of Use costs), and/or charge or demand penalties of the zone, overall, EVs can be charged for use while balancing the costs to the facility. This may include, in accordance with some embodiments, ensuring that optimisation can be done through prioritizing EV charging based on predicted or planned future fleet needs, or considering optimised costs when using end use rate structures. In accordance with some embodiments, optimizing the charging of vehicles may include the consideration and application of various methods of charging through control instructions, non-limiting examples of which may include varying the rate of charge (or discharge) to put stored EV energy back onto the grid, timing of charge, or limits of charge over a period of time.

FIG. 1a depicts a high-level view of an exemplary Recommendation Engine, which includes one or more computers that communicate with one or more databases, which communicate with additional systems or databases that relate to energy information 5200. In accordance with some embodiments, the optimisation engine 020 may digitally execute one or more processes described above with respect to, for example, optimisation 2208 of FIG. 22B, or optimisation 2306 of FIG. 23, although it will be appreciated that the engine 020 may be configured based on the application or use case at hand, non-limiting examples of which are further described below with respect to, for example, FIGS. 4, 5, and 9 to 19. In the exemplary embodiment of FIG. 1a, databases and systems relate to building management systems or energy management systems 5200, charging systems 5020, charging- and EV-related information and control systems 5300 (such as BMS/EMS 5010, EV charging systems 5020, or fleet telematics and planning 5030), fleet management and telematics information and control-related systems 5400 (such as EV charging systems 5020 or fleet telematics and planning 5030, or delivery management systems 5030), and delivery management-related information and control systems 5500. While the engine 020 may be operated in a live environment, it should be appreciated that a simulation may also be done, such as through digital twinning of all or a portion of the environment.

It should be appreciated that while many of the specific systems (BMS 5010, EV charging 5020, etc.) operate independently, the engine 020 is configured to communicate with each specific system and perform optimisation through analysis of an optimal energy usage for a specific user or groups of users, based on the requirements or constraints of each of the systems, which traditionally operate independently. In some embodiments, this may be beneficial because, in many cases, the optimum energy use of one system may contradict with or be sub-optimal for the energy needs of another system or sub-system. For example, keeping energy use below a demand penalty threshold may run counter to fleet management, which seeks to ensure that all EVs are 100% charged as soon as they are returned to the fleet facility, or charged to address an immediate EV need.

The engine 020 may optimise energy use by, for instance, taking into account actual and predicted demands as they relate to not only building use, but also EV fleet use. In accordance with some embodiments, the engine 020 may enable modelling to make predictive calculations based on data inputs, and provide recommendations and action plans to effectively optimise the energy profile of a facility and electric vehicle fleet. Given the high complexity of managing these inputs, the engine 020 may, in accordance with various embodiments, employ various processes and systems related to machine learning or other artificial intelligence processes, such as deep learning methods, supervised learning, unsupervised learning, reinforcement learning models, or the like.

While a building management system or energy management system may be specific to a building that also houses a charging station and delivery or warehouse facilities, it will be appreciated that it may relate to a multi-building or multi-site location that is considered as a single zone from an energy or cost perspective for some users. As such, while some of the embodiments described herein may refer to a zone as a building, it will be appreciated that similar architectures may be applied to a wider zone of coverage, such as a multi-building facility, campus, multiple separate locations that are managed or owned by one user, or the like. For example, a zone may comprise multiple shipping warehouses that are dispersed geographically, but owned and managed by a parent company.

While the engine 020 of FIG. 1a is depicted as a cloud-based network, system, or platform using one or more remote servers, which allows for ease of connection to other systems, such as the BMS for building control or the power utility for grid pricing information, it may also be a local system installed or operated at one site, or operated as an edge computing system. It can also be appreciated that the engine 020 can be embedded in a hardware component in the system, such as within an EV charging station, or within a building energy smart meter or building control system or other hardware component. This may allow for any hardware installation (e.g. the EV charger, or building management controller) to act as the engine 020, as well as the hardware itself. In accordance with some embodiments, requested and collected data may include both historical and real-time data or information, one or both being used in the optimisation analysis by the engine 020. Due to the number of servers or systems that the engine 020 may communicate with, the engine 020 may also employ security modules, such as standard approaches to authentication and verification of data, or other security techniques known in the art.

And while the engine 020 operates as a single installation in a zone or for a building/EV charging facility, it can be appreciated that multiple implementations of the engine 020 may be applied across various locations, and each implementation provides its recommendations to the other implementation (or a master engine) as an input, thereby allowing individual engines to participate in a wider application of energy optimisation for a multi-site, city-wide, state, or national approach to optimizing energy as described.

In accordance with some embodiments, FIG. 1b depicts in greater detail an exemplary architecture, how it interacts with other EVs, vehicle fleets, energy or building information, and management systems, and the instructions and/or control information that the engine 020 may provide in return. The incoming/outgoing data, information, and/or control commands are sent over a communication network that connects the engine 020 to other systems. The communication network may connect the engine 020 to some or all portions of the system. Some or all of the information or data may be transferred over one or more methods or paths of connection. In one embodiment, the information may be unidirectional, and in others bidirectional. In yet another embodiment the communications may be connected to a public or private network, and may also be encrypted or secured using traditional data security methods or processes. The communications network may be wired, wireless (e.g. Bluetooth, satellite, cellular or other), or a utilise a combination of both.

As shown, data may be communicated from an energy cost- or control-based system, such as a Demand Response system module 5040, which typically is connected to a power grid 5041, and an energy user, such as a building (or Facility) 5042, or Charging Stations and/or Vehicles 5050. For fleet management of one or more vehicles, information or data is monitored, managed, and controlled through at least one of several systems, which include a GPS Tracking & Vehicle Telematics system 5060, a Delivery Management unit 5070, which includes Route Planning & Scheduling Operations 5071 or other logistics related content, and a Last Mile Efficiency system 5072. Data or information from these systems is communicated to the Engine 020, and may be communicated from various systems that operate independently, such as a Building/Energy Management System (BMS/EMS) 5010, a Connectivity Charging & Monitoring system 5020, and a Fleet Telematics & Planning system 5030. The optimisation engine 020 analyzes all or a portion of the incoming data or information to optimise the use of energy, and issues either data to a user to recommend an action, or issues a control command back to at least one of the systems to automatically enable the recommendation. It may also communicate to receive or send information directly from a user (not shown), who is either independent of any of the systems, or is a user of one of the systems. The optimisation engine 020 may enable a real-time output execution through the consideration of possible iterations and implementations. In some embodiments, this may be done using at least two control systems, non-limiting examples of which may relate to energy, charging & EV, fleet management, and delivery management. It may be appreciated that the optimisation engine 020 may be embedded in any one of the other systems (e.g. BMS/EMS, charging, delivery management, or the like) in place of a separate software-based engine.

As noted above, the Delivery Management unit 5070 includes Route Planning & Scheduling Operations 5071 or other logistics-related content, and a Last Mile Efficiency system 5072. Also included in delivery management for fleet management is information that enables the recommendation engine to make optimised calculations and recommendations by considering logistics information that may impact EV energy needs, such as, but not limited to: allocations of energy use related to loading time, shipping and preparation time, projected route-specific changes that may occur due to historical trends (e.g. increased traffic and energy needs due to a holiday time, projected increase in on-demand or day-of package pickups, or the like), freight management-specific needs (e.g. added energy use for a vehicle that has refrigeration due to type of freight that is transported, such as perishables, or availability of delivery drop-off and storage locations where freight could be combined to one drop-off point, which includes on-demand warehousing of freight). Use of the optimisation engine enables delivery management or freight logistics to be optimised not only for shipping needs, but also to account for dynamic energy needs and costs.

The engine 020 also includes a report module or alert module (not shown) that can be used to send real-time or historical reports to users of any of the systems (e.g. Building manager, Fleet manager, Finance manager, or the like). These may comprise, for instance, a report or alert on various recommendations, such as energy reductions, building management optimisations, fleet redeployment, fleet management related information, or the like. For example, the engine 020 may recommend the optimisation of both the charging schedule timing of the EV fleet (or portion of the fleet, or other logistics of the fleet) alongside production timing or shift changes of equipment operations based on upcoming goals or constraints of projected increase in fleet use (e.g. holiday time and increased deliveries, or the like). In another example, reporting from the engine 020 may be used for a fleet manager to recommend lower energy costs (and thus fleet operation costs) due to delayed charging that will not impact overall fleet charging requirements, yet may eliminate peak demand charges that are projected to occur. In another example, the alert module alerts a building manager of a demand penalty due to higher-than-expected charging from the EV fleet, which may happen if the fleet vehicles return earlier than expected. In accordance with one embodiment, such an alert received from the engine 020 via, for instance, a mobile device may enable the building manager to make a decision on EV charge delays in real-time, or contact the Fleet manager about revising the charging requirements of the vehicles.

Not shown in FIG. 1b is the use of smart grid technology, which may also include multiple energy providers and purchasers that may interact with the BMS/EMS 5010 system, in accordance with one embodiment.

Typically, energy data for a facility zone is used to manage vehicle charging. However, FIG. 1c depicts an exemplary method or process 300 of operating the engine 020 that calculates and optimises energy needs from a wider view, in accordance with one embodiment. The following steps are shown. Energy costing or availability data is received 302 or held by the engine 020, such as Demand Response information or variable billing rate information. It may also include local energy cost data or availability onsite energy generation data. Data such as vehicle data relevant to the charging vehicles (or estimated vehicle data based on vehicle types) may further be provided 304 to the electric vehicle charge optimisation engine. This may include energy use of the vehicle according to at least one of many ways, such as energy needs by distance, weight of vehicle, time deployed, or other. Fleet data is provided 306 to the electric vehicle charge optimisation engine. The fleet data may also be considered vehicle or facility logistics related data or information related to vehicle or fleet needs. Fleet data includes projected fleet schedules. Non-vehicle data or attributes related to the facility zones energy needs may further be provided 308 to the electric vehicle charge optimisation engine. This may include any energy consuming device in the facility or zone, such as HVAC or lighting. It should be noted that negative energy use data may be provided, such as when a facility produces its own energy via wind, solar, or battery storage. Based on the above data, setpoints, and/or rules provided or set by a user 310 the software engine may perform an energy usage optimisation calculation 310. Implementation of the recommendations 312 is done when the engine 020 provides charge instructions to the vehicles at the charge stations based on the energy usage optimisation calculation.

In applying these steps, it may be appreciated that additional inputs or variations may occur during, for instance, the data analysis and control or charge instructions, in accordance with various embodiments. For example, control instructions may also be given to non-vehicle devices in the building or zone to balance out the energy use, instead or alongside charge instructions for the vehicle. Alternatively, or additionally, EV charge instructions may vary, such as instructions relating to a simple on/off, a % of maximum charge, delay of charge, trickle charge at a reduced energy charge, or a combination of such instructions either for one vehicle, or multiple vehicles, or a bank of vehicles. This may include priority of specific groups or single vehicles, or timing of charges that may vary by vehicle. Setpoints, and/or rules may further be provided or set by a user for consideration, such as a minimum charge reached per vehicle, maximum or cost limits without manual authorization for more charge, or similar. Energy data used in the optimisation calculation may also vary, and may include known variables, non-limiting examples of which may include demand response data, energy cost, time of use penalties, kw, kwh, current, voltage, or predicted energy consumption. Further, vehicle data used in the optimisation calculation may vary, and may include known variables, non-limiting examples of which may include battery capacity, state of charge or charge levels, rate of charge/discharge, weight, age, temperature, available use or life remaining based on current use (in driving time or distance or both), or other relevant historical battery information. The vehicle data may come from various sources, such as the vehicle or Battery Management System itself, the user, a 3rd party, or the like.

In accordance with various embodiments, vehicles may typically include electric automobiles. However, it will be appreciated that, in accordance with other embodiments, robot vehicles (e.g. passenger or freight moving vehicles, or autonomous mobile robots which may be used for inventory delivery in a warehouse) may be have charge regimes optimised using similar processes.

Furthermore, it will be appreciated that an optimisation calculation may employ more advanced calculations and algorithms, such as machine learning algorithms, in accordance with various embodiments.

In accordance with some embodiments, optimisation calculations may be used as a tool to analyze but not provide changes to an active system (e.g. using digital twinning of the data, or using another simulation model), or used in near real-time or real-time and taking into account the dynamic energy needs of the zone, and the vehicle and non-vehicle energy needs.

Additional data or datasets may be included, such as custom datasets provided by a user that factor into forecasting as they may impact energy demand (e.g. building occupancy, weather projections and related feeds), in accordance with some embodiments.

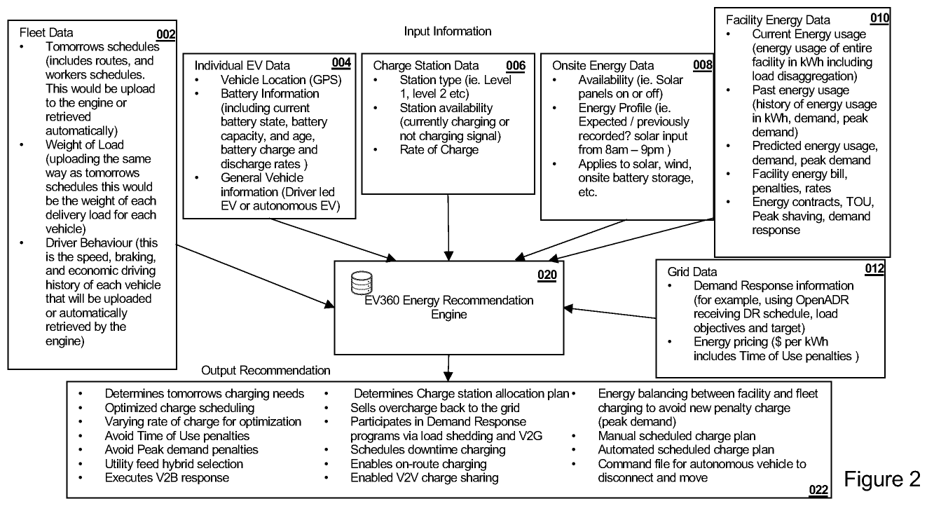

Referring now to FIG. 2, an engine 020 may consider various information or data from various sources related to fleet, vehicle, charging, or energy-based data (onsite, facility, or grid).

To address the challenges of commercial, fleet, or residential electric vehicles fleets that balances both the load of the charging facility or building and the charging needs, the engine 020 works to optimise charging needs based on several variables, which include but are not limited to fleet 002 or vehicle-specific data 004, charging station data 006, onsite 008 or facility needs 010 data, and grid or micro-grid energy information or data 012, in accordance with one embodiment.

In accordance with one embodiment, fleet data 002 is the data feed that provides information about the fleet or grouped vehicle usage. It may be appreciated that a fleet may also be one or more vehicles, or be subsets of a group of vehicles. Fleet data feed may come from multiple sources including workforce management systems, order and dispatch systems or other systems that may provide relevant information, from the EV fleet will be either uploaded manually by fleet managers or retrieved automatically by the engine 020 itself. The Fleet data provides critical information about the work that is required for the facility that requires the EV's use. For example, information pertaining a future delivery schedules (e.g. next shift, tomorrow, or any future time period) including delivery routes, total distance of each vehicle needs to travel, workers schedule including start times, break times and end times, weight of delivery load for each vehicle (which may include information on how weight of cargo affects battery usage and thus may impact charging needs, or driver behaviour which is past speed, and other energy use tied to the vehicles based on information such as economic driving habits of each driver or vehicle). For example, vehicles may require different energy charges for a day's planned delivery based on expected routes (heavy local traffic vs highways with no projected congestion, or additional or extended delivery times due to an influx of pickups or package deliveries expected).

Individual EV data 004 may comprise a data feed that contains specific information that comes from the actual electric vehicle, and contains information including vehicle location data in the form of GPS, battery information including current battery state (charge status) that is the amount that the battery is currently charged, battery temperature and age, battery capacity (e.g. the max charge the battery may hold, which may change with age and temperature), battery charge and discharge rates, and general vehicle information, such as if the EV is autonomous or non-autonomous.

Charge station data 006 is the data feed from the individual charging stations and may include the following information which man be uploaded from each charge station via known charging station related protocols such as Open Charge Point Protocol (OCPP) or other charging related communication protocols. Within each facility or building group, there might be multiple different types of chargers that charge at different rates, such as level 1 chargers, which are 120 Volts, and level 2 chargers, which are 208-240 Volts and may charge at a much faster rate than a level 1 charger, or level 3 chargers. This charge station type information is transferred to the engine 020 and taken into consideration while planning a scheduled charge. Typically, a facility will have a charging/parking area where a charger or multiple chargers are located. Charging station or facility location information is also used such that the engine 020 may know where each specific charge station is located. Location based charging may be used by the engine 020, where energy costs and usage limits are set by location. Charge stations will also send their current charging status such as are they in use or not in use and the rate of charge. It should be noted that an EV may include various types of electrically driven vehicles or machines, non-limiting examples of which may include automobiles, vans, trucks, heavy or industrial equipment (forklifts, excavators), mobile manufacturing equipment, or facility or warehouse equipment such as autonomous robots requiring charging.

Many facilities might have on-site energy generation such as wind, solar, battery storage, or other types of alternative energy typically used by a facility or building to offset or replace grid power. On-site energy data 008 communicates with the engine 020. Energy data may include energy availability throughout the day or other time period. For example, if the facility is using solar panels, but it is a cloudy day, the solar panels might not be working at full capacity. The engine 020 may then be told the projected capacity at which the solar panels are currently working which may be relied on for current or future charging needs. The engine 020 may also be sent a historic energy profile for all of the facilities onsite energy to help enable modeling of energy production. For example, if the facility has both wind and solar and has a previous history of wind between 7-10 pm and solar from 9 am-9 pm, the engine 020 will then be able to take into account the expected excess energy within the times and make optimisation decisions for the days charging. This may apply to solar, wind, on-site battery storage, or any other onsite energy option, in accordance with various embodiments.

Many facilities will have pre-existing energy management systems or building management systems, or a combination of both. These systems are generally a series of digital metering systems which are installed throughout the facility on load circuits, and software that extract information from the meter and store the data in a local database or cloud-based system. Some systems use a hybrid approach and store onsite and in the cloud. The data that is stored is a representation of the energy usage of a particular circuit or a combination of circuits. When all the meters are added together, one may understand the total energy usage and energy profile of the facility. The information that comes from the system is the Facility Energy data 010, in accordance with one embodiment.

The engine 020 may utilise the data from the Facility Energy data 010 in its calculation routines. This Facility Energy data 010 may include a plurality of energy parameters, non-limiting examples of which may include kW, kWh, kwDemand, kVar, kVarh, kVarDemand, Power Factor (PF), and individual load information including criticality of the load, which could be an indicator of whether the load could participate in a demand response action. The data may tell the engine 020 which load within the facility is using what amount of energy. In one example, the engine 020 utilises the past energy usage within the facility to outline the lows and peaks in energy usage throughout the day, and, if available, the predicted energy usage for the next days, which may be based on past energy usage. These predicted models outline when peak demands might be reached, a potential facility energy bill, monetary penalties, and charging Time of Use energy rates throughout the day. The engine 020 may also have access to pre-existing energy contracts within the facility including Time of Use rates, demand charges, power factor penalties, peak shaving penalties, rebates, chargebacks and facility demand response and other parameters that may affect the overall electric utility bill.

The energy demands noted above come from various uses of non-vehicle equipment, such as equipment to operate production lines, sorting lines, HVAC, lighting, manufacturing equipment, or other equipment such as autonomous robots or production vehicles (e.g. electric forklifts) used for warehouse or facility operations. It will be appreciated that robots or production vehicles may be considered a vehicle or non-vehicle load, and classification of all or some into one category for the engine 020 analysis may vary depending on the user. Insight into the building or facility use, and where the energy use (and cost) occurs, is an important activity in performing a calculation on optimizing actual energy demands against critical needs. For example, a recycling company may have a fleet of electric vehicles that come back to base at various times to unload. The base operation then has to turn on high energy equipment to sort, compact and grind various materials for recycling. The load profile of the base operation varies throughout the day based on the schedules of the returning trucks. In some situations, the returning trucks may need to be recharged during the base stay before returning to the roads for another collection run. In some situations the trucks remaining charge may be discharged and placed back on the grid to offset the additional high energy loads to prevent peak demands from occurring.

Grid data 012 is communicated to the engine 020. This may include demand response information which may be communicated using protocols known in the art, such as the OpenADR standard to receive DR scheduling, and load objectives and targets, such as a time window in which to shed load, and/or a quantity or volume of load to shed. The grid data (or energy data) may be provided from local storage or may come from a cloud-based storage of the data or information. The grid operator or grid management system will also communicate changing energy prices in dollars per kWh throughout the day, and possibly next day pricing. This may include possible Time of Use penalties, demand penalties, power factor penalties, and various rates for different end use loads based on the type of load connected. For example, an end use load may be an electric vehicle, and/or may have a different rate structure than other loads. The engine 020 considers the different rate structures into its calculation when determining its optimised output.

Recommendation engine 020 receives multiple input from the grid data 012 energy data 010 008 EV data 004 charge station data 006 and fleet data 002 and performs the following tasks 022, in accordance with one embodiment: determine the upcoming optimised charging needs for each individual EV (may be by day, by shift, or other time period), provide a manual or automated scheduled charge plan that varies the rate of charge for optimisation, while providing a recommendation that avoids desired Time of Use and Peak demand penalties or other penalties, while taking into account schedules for downtime charging which is short charging sessions throughout the day either on-route or at facility during necessary downtimes such as scheduled worker breaks or loading or unloading the vehicle or anytime where the vehicle is not in motion, enable the use of on-route charging which is the possible of charging via a charge station network while vehicles are away from the facility, and/or vehicle-to-vehicle (V2V) charge sharing which is the ability to discharge one vehicle's charge to another in a time where it is necessary such as when facility peaks are high and another vehicle is in need of a charge.

In one embodiment, the engine 020 will also determine a charge station allocation plan and a command file for autonomous vehicles to disconnect and move charge stations, and provide an optimised energy balancing between facility, fleet charging, and onsite energy alternatives to avoid monetary penalties such as Time of Use, Peak Demand, or the like, within the facility. The engine 020 will decide the optimum scenarios and utilise various methods to achieve this. Those methods may include selection of different utility sources including external utility feeds or onsite generation, or a combination of both. It may also optimise further by various optimised charging plans, or discharging vehicles to supply energy back to the building (Vehicle-to-Building, or V2B), selling energy stored in the vehicles back to the energy grid for use by others (vehicle-to-grid, V2G), or participating in demand response programs by load shedding through ceasing fleet charging or slowing down the rate of charge of the fleet, or discharging back to the building or grid through V2G. These methods of optimizing may be used alone or a combination with a one or more of the other methods.

In accordance with some embodiments, optimisation of the engine 020 may be enabled through real-time analysis of data in a mathematical model using machine learning or artificial intelligence approaches. Optimisation may occur when the engine 020 works in conjunction with various data inputs or variables to optimise the variables and recommend the best or most efficient option to enable EV charging in a vehicle or fleet of vehicles. Generally, it uses setpoints or boundaries to assist in this analysis and results in a more efficient charging approach to the vehicle(s), that considers important inputs such as fleet data, building data (or building attributes such as required energy needs), charge information, and/or energy cost or grid data.

Exemplary setpoints, rules, or boundaries that a user or manager may set include, but are not limited to, a safety margin, cost margin, a full or partial override to ensure that full charging of a fleet still can be enacted if required, regardless of optimisation recommendations, energy cost monitoring where costs may be incurred but re-allocated, so to be accounted for in, for example, any cost analysis, or fleet charges that may be broken out to charge a driver or package owner for energy use as a part of delivery cost. The rules or boundaries for similar variables may also vary between the modules noted above. For example, the predictable or static load related to day-to-day operation of a building may have a narrower demand response limit than that of an EV (meaning it would be more preferable under-utilise building asset energy uses via a larger safety margin for energy use, compared to an EV charge threshold which may have a narrower safety margin to allow charging up to a demand response limit). Variations in the rules across modules allows for an optimised result for the user that better balances the needs of usage.

As further detailed below, the Engine 020 may use several different methods and approaches to perform its assigned tasks 022, each with its own set of inputs and outputs particular to the given need of the user (e.g. facility manager, fleet manager, EV driver, or the like). These techniques and their implementations may each be picked for specific tasks given that there are not only classification and regression-based algorithms in use but also predictive modelling and decision-making approaches. Approaches that the Optimisation Algorithm may use include a Neural Network approach, a decision tree or random forest approach, and a linear regression (or ordinary least squares regression) approach, or the like. It may be appreciated that other forms of optimisation or calculation may be utilised to arrive at a similar output, in accordance with other embodiments.

The following example, shown in FIG. 3, discusses the implementation of a neural network approach with the Engine 020, which has a basic neural network structure 5100 including the features 5110, the hidden layers 5120, and the output 5130, which we may also call our inputs 5110, and intermediate calculations/decisions 5120. The Engine 020 uses this process structure to conduct a comparison (e.g. comparing a set of possible outputs for the given use case, generally related to cost, scheduling, or energy allocation), and choose the optimal solution 5130 found through the intermediate calculations 5120.

The “features” or inputs 5110 for each neural network are given in each use case and curated specifically for the task that the algorithm is carrying in that instance. Using these inputs the optimisation Engine 020 will work through the “hidden layers” or intermediate calculations 5120, and near the end of these hidden layers, begin to eliminate possible outputs. In the exemplary case of FIG. 3 the possibilities from the “b layer” to the “c layer” go from 4 outputs to 3 since, for instance, there may have been an output that did not follow some of the boundaries described in the input variables. The “concluding layer” 5121 is the final layer in the hidden layers and is the step where the final output decision is made by conducting a direct comparison between the remaining options, in accordance with one embodiment. FIG. 3 further shows the 3 outputs in the “c layer” before a final optimised output 5130 is selected as a result of the algorithm's features.

### Use Case #1

By way of a first example of a charging scenario, an Engine 020 may enable a facility manager or fleet manager to charge their fleets accurately to avoid wasted energy, which results in cost savings for the facility or fleet operations. It enables this by determining the upcoming charging needs and charging vehicles to at least the minimum required capacity.

In this implementation, represented by the diagram in FIG. 4, the user, which might be the Facility or fleet manager, wishes to charge their electric vehicle fleets to the minimum charge required for the projected operational needs, which will assist the user in reducing charging costs and avoid wasted energy 100 or peak demand charges. The Engine 020 communicates with other servers or databases to receive data, wherein the data may include, but are not limited to, individual EV data 202, Fleet Data 204, and charge station data 206. Using the Data inputs 200, the Engine 020 performs the assigned task 230 and may determine future charging needs 232 for the electric vehicle fleets (e.g. charging needs 232 for tomorrow). It will be appreciated that future needs 232 may relate to any future time period of any length. In some embodiments, the Engine 020 may determine the charging need of each individual electric vehicle in the fleet based on fleet data 204, which may include individual schedules, predicted distance traveled, current battery capacity, past battery usage, driver behaviour, or the like.

The future schedule and route information are to be given by the fleet manager or an external source and may include (but are not limited to) delivery stops along the route and estimated total route time. This may generally relate to a 24-hour period, but may be for shorter (e.g. shift-based) or for longer (long haul based) schedules. This information enables Engine 020 to determine the minimum required charge the vehicle will need the next time period. Additionally, there are external services that help with the battery estimations for routes, such as Google Maps, which calculates how much battery a route will take and will also factor in any necessary charging stops along the way, along with re-calculating routes to include charging station stops. The combined data of route planning and battery requirements may be converted into charging needs for the vehicle by the Engine 020.

Once the charging needs of each individual vehicle are calculated, the Engine 020 will also determine a charging order for the vehicles and begin charging based on the vehicle with the highest priority, should the facility manager wish to prioritize charge. In accordance with some embodiments, priority is determined by two main factors: the amount each vehicle needs to charge, and scheduled departure time.

Each charging amount is determined given the difference between existing battery state and necessary battery state for tomorrow's route (outlined above), with the addition of a safety buffer charge (to compensate for miscellaneous obstacles such as traffic, time the vehicle is left running during the actual delivery, etc.). This value for the safety buffer may be changed by the fleet manager. However, a buffer of, for example, 5%, may be set to be included in the Engine 020 charging calculations. The vehicles that need to charge more will have a higher priority than those who do not need to charge as much, or at all, in order to avoid Time of Use and/or Peak demand or any other penalties, restrictions, and/or boundaries given by the Grid Data or manual inputs.

Scheduled departure time is determined by the delivery time of the vehicle's first order, typically the following day. Using a route planning service, the Engine 020 calculates the latest time the vehicle will need to depart in order to complete the task on time, which enables the facility manager or fleet manager to plan departure times that maximize the charging efficiency of the fleet. The vehicles that will need to leave earlier will have a higher priority than those whose departure times are later. For example, the Engine 020 may determine that based on Vehicle A's schedule, it needs 85% charge for tomorrow. That includes 70% to complete all deliveries and return to the facility, plus 15% for safety. Vehicle A's departure time is 10 hours from now, and its current battery state is 35%, meaning it must charge a minimum of 50% of its battery before then.

The Engine 020 also determines that based on Vehicle B's schedule it needs only 65% battery capacity for tomorrow, including 60% to complete all deliveries and return to the facility, and an additional 5% for the safety buffer. Vehicle B's departure time is 12 hours from now, and its current battery state is 30%, meaning it must charge a minimum additional 35% of its battery before then.

In consideration of peak demand charges and energy costs (e.g. it may be more costly to charge both Vehicles A and B simultaneously), and given that Vehicle A's charging need is greater than that of Vehicle B and its departure time is also earlier, the Engine 020 may determine that Vehicle A has a higher charging priority. The Engine 020 will charge Vehicle A until it is sufficiently charged for its route, and then charge Vehicle B until it is sufficiently charged for its route. If there are multiple charge stations available at the same time, the Engine 020 will determine that, since Vehicle A has a higher charging priority, it will use the higher-level charger, or the charging station with the highest charging rate. It may be appreciated that, in this example where a facility manager or fleet manager has several or even hundreds of vehicles that may have staggered start and finish times, the Engine 020 enables a managed charging solution that considers energy costs as well as fleet use requirements.

The following is a more description of the Engine 020 as it relates to the first example, and implementation of a neural network process. It may be appreciated that the different types of processes implemented may be chosen to perform their respective tasks, and that a combination of the techniques may be employed to provide the specific outputs.

The first step an engine may take is to determine features and uses of data inputs. Given the tasks that the Engine 020 is expected to conduct, it may be determined that there is one primary output that may be determined, in accordance with one embodiment: the charging need of each vehicle in the fleet based on individual schedules, tomorrow's routes, current battery capacity, and estimated battery usage. The intermediate calculations also feature a charging priority determination method that the Optimisation Engine 020 may use.

To obtain the desired output there may be several smaller computational processes that break the task down into smaller tasks, working cohesively to minimize error and maximize efficiency. FIG. 3 illustrates three intermediate processes that focus on: estimating the next day's energy consumption for each vehicle, calculating how much each vehicle must be charged for tomorrow, and determining the charging priority of each vehicle. The features for these intermediate algorithms may be listed as such:
1. Tomorrow's Energy Consumption features:
   Tomorrow's vehicle route (manual input)
   Battery usage rate (manual input, which may be found from vehicle manufacturer, and adaptive based on inter-city or highway travel per route)
2. Necessary Charge Calculation features:
   Tomorrow's energy consumption
   Current vehicle battery charge
   Charge safety buffer (manual input)
3. Vehicle Charging Priority features:
   Number of vehicles (manual input)
   Vehicle necessary charge calculation
   Vehicle departure time (manual input)

The hidden layers that perform the calculations for Tomorrow's Energy Consumption may use two manual inputs to perform a direct calculation: tomorrow's predetermined route, and the vehicle battery usage rate. With the use of external software (e.g. Google Maps, GPS tracking, etc.), the route distance and estimated route time may be calculated. After determining if the majority of the route uses highways or inter-city roads the Engine 020 uses the correct battery usage rate and the estimated route time to perform a calculation by multiplying the two together to determine vehicle's energy consumption for the next day.

The hidden layers that perform the Necessary Charge Calculation use the consumption value previously calculated, the current vehicle battery charge, and a manually set charge safety bugger as their three inputs. By subtracting the current battery charge from Tomorrow's Energy Consumption the Engine 020 determines how much the vehicle needs to charge overnight. The implementation of the manually pre-set charge safety buffer accounts for extra energy that may prove crucial should there be any obstacles or delays such as unprecedented traffic or route detours.

The hidden layers that curate the Vehicle Charging Priority use the necessary charge value previously calculated, the number of vehicles, and the individual vehicle departure times. By sorting each vehicle based on their departure times (thus determining how long until they leave) the Engine 020 then takes into account how much each vehicle must charge before departure (per the Necessary Charge Calculation). The output may resemble a list of the vehicles numbered or ranked in order of priority where the highest charging priority vehicles may have either earlier departure times or require greater charges.

### Use Case #2 Charge Scheduling to Lower Facility Electricity Spend

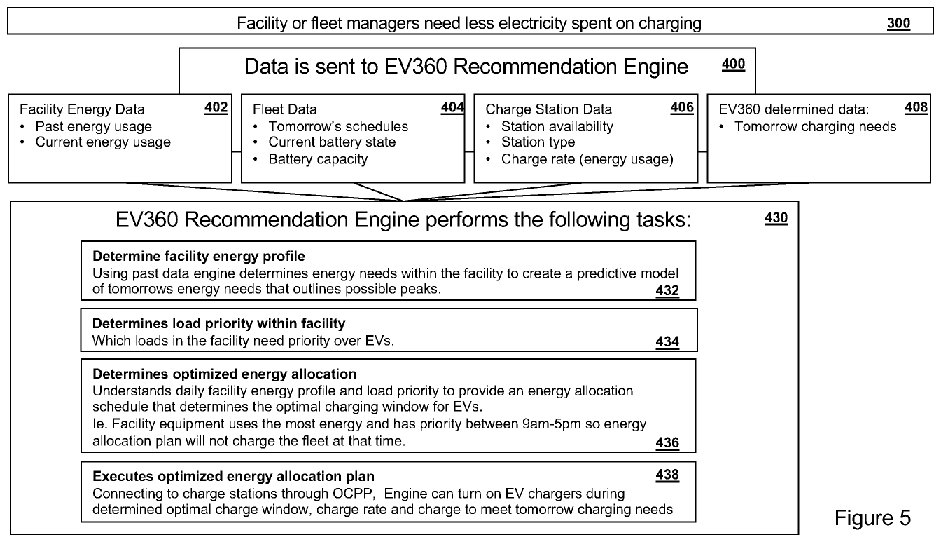

By way of a second example, and with reference to FIG. 5, the Engine 020 enables a facility manager or fleet manager to optimise and execute on charge scheduling, which lowers facility energy costs overall. It enables this by determining the upcoming charging needs (through energy profiling and load priority of facility assets) and executes on an energy allocation plan that accounts for both non-vehicle energy asset needs and EV needs.

In this implementation, the user, which might be the Facility or fleet manager, needs to optimise electric vehicle fleet charging to lower facility electricity spend 300. When initiated, various data inputs are sent to the Engine 020. These inputs include data as described earlier that come from Facility Energy data 402, Fleet Data 404, Charge station data 406, and EV360 Determined Data 408. It should be appreciated that in this example, and other examples in this description, the EV360 Determined Data 408, such as the charging needs of the vehicle for a later time period, may be determined or calculated by the engine 020, or may be provided by an alternate or independent provider, such as the fleet telematics or fleet management database of a fleet manager or delivery management organization.

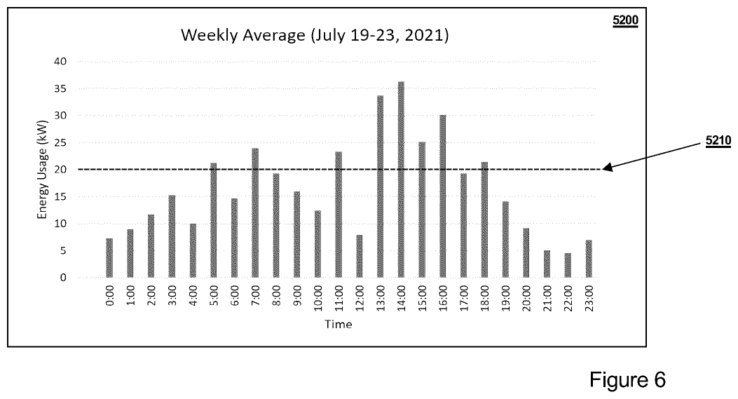

Next, the Engine 020 utilises the data received 400 to perform the following tasks of energy profiling and optimisation 430. The Engine 020 calculates the facility's energy profile 432 using historical data to create a predictive model of tomorrow's energy needs, which includes projected energy peaks throughout the day. A non-limiting example of such a predictive model using a previous week's data sample that shows on-peak times, off-peak times, and an energy peak threshold is shown in FIG. 6. An engine 020 may then determine load priority within the facility 434 and flag loads that need priority over electric vehicle charging.

A non-limiting example of this may be the Fed-Ex® sorting and dispatch facility. The facility itself has a varying load profile throughout the day and night. The load profile depends on what machine is operating, the temperature outside, number of staff at the facility, conveyor belts, motors, heating, cooling, and staff schedules, and the like. There may be other electrical loads within the facility that affect the facility load profile.

In addition to the facility load profile there is the EV charging load profile which when added together gives an accurate picture of the overall load profile for the site. The addition of the facility load profile and the EV charging load profile is what is used by the utility to bill the customer.

The Engine 020 may then determine an optimised energy allocation plan 436 that includes both the vehicles and the facility needs. By understanding the daily facility energy profile and load priority the Engine 020 will create an energy allocation schedule 436 that determines the optimal charging window for electric vehicle charging, while also considering overall facility or building needs.

With this energy allocation schedule 436 and the understanding of the daily facility energy profile 432 and load priority 434, the Engine 020 will determine a timeframe when the vehicles may not be charged due to other facility equipment or utilities that have a higher priority than that of the vehicle charging. As a result, the Engine 020 allows a facility manager to balance both the EV charging needs with the facility needs and ensure overall energy costs are considered and proactively managed. Using this timeframe the Engine 020 may also determine when the vehicles may be charged. Cross-referencing these timeframes with the energy allocation schedule will result in the optimal charge windows, in which the Engine 020 charges the vehicles based on their charge priority and individual schedules via charging protocols, such as Open Charge Point Protocol (OCPP) or Open Smart Charge Protocol (OSCP).

There are several charging protocols or standards that enable an EV to communicate with the charging station and/or energy supplier. Open Charge Point Protocol (OCPP) and Open Smart Charge Protocol (OSCP) are two widely-accepted public EV charging standards that outline the use and implementation of electric vehicle charging stations. These are two known communication protocols that connect back-end systems to the charging stations which enable many different features such as two-way power flows, data exchanges, real-time control, and eMobility services. OCPP specifically was designed to encompass the use of flexible energy resources and adapting the OCPP to available energy capacities which allows for the measuring, metering, and optimisation of energies. These two protocols will be mentioned as the standard practice; however it is important to note that these are not the only standards that could be implemented and the Engine 020 is compatible with other communication methods and proprietary protocols, in accordance with other embodiments.

With the implementation of communication protocols, such as OCPP and OSCP, the Engine 020 receives and transmits both data and control to the charging stations, meaning that it may turn the individual charging stations on and off according to the optimal charge windows. In operation this allows the charging on/off to be managed at the charging station level, via the Engine 020.

For example, facility equipment might use the most energy and be flagged as priority between 9 am-5 pm so that the energy allocation plan would not charge the fleet at that time. The Engine 020 may execute the optimised energy allocation plan 438 by connecting to the charge station through OCPP/OSCP, and may turn the charging stations on and off during the determined optimal charge windows to charge the fleet accordingly to meet tomorrow's charging needs.

The implementation of the new optimised energy allocation plan 438 allows for a more time- and cost-efficient method of vehicle charging, and results in a much more ideal energy spending and/or use. Charging the vehicles during the determined timeframe and in the gaps in between the energy peaks of the facility will lower energy costs and overall spending.

### Optimiser Engine Application (Use Case #2)

The following example is a description of how the AI Optimisation Engine 020 relates to the second example. It should be appreciated that different types of processes may be implemented, and that each may be used to perform their respective tasks. The combination of the techniques or algorithms work to provide the specific outputs as needed.

The first step the AI Engine 020 takes is to determine the features and what each of the inputs will be used for. Given the tasks that the optimisation Engine 020 is expected to conduct, it may be determined that there are three primary outputs specific to this use case that the Engine 020 will perform: a predicted facility energy profile, an optimised energy allocation plan, and then the execution of the optimised energy allocation plan. The features may be listed and assigned to the following tasks that may be performed as such:
1. Predictive Energy Profile features:
   An empty 24-hour schedule
   Previous facility energy profile or usage data (without EV charging data)
2. Schedule Optimisation features:
   Tomorrow's charging needs (as determined in Use Case #1)
   Charging station availability, type, and rate
   A list of prioritized facility energy loads or utilities (to come from a manual input)
3. Optimised Energy Allocation Plan Execution features:
   Real-time facility energy profile or usage data
   Real-time vehicle battery states

The “hidden layers” or intermediate calculations for the Predictive Energy Profile first take the previous facility energy usage data and analyze them according to the 24-hour schedule. This then predicts on-peak and off-peak periods throughout the day by calculating the average energy usage and prices during each of the slots in the 24-hour schedule. Using the average energy usage at each hour the Engine 020 may predict what the approximate energy usage for the next day will look like at the beginning of each hour.

As shown in FIG. 7, the Engine 020 uses the previous week's data sample and shows on-peak times (roughly 1:00-4:00 in the afternoon and 5:00-7:00 in the morning). The algorithm may use this to predict the average energy profile for that day. With the addition of energy prices at each hour the Engine 020 may also determine the daily price of energy.

The hidden layers that perform the Schedule Optimisation calculations and decisions first take the empty 24-hour schedule and create all the possible schedules to meet Tomorrow's Charging Needs. After all the possibilities have been considered the Optimisation Algorithm uses the predicted energy profile model and prices from the predictive model above. It will then calculate the approximate daily energy costs for each schedule and select the least expensive option to maximize energy savings. This algorithm uses a neural network approach and may be illustrated in FIG. 7, which shows a neural network approach the Optimisation Algorithm uses to create the Optimised Energy Allocation Plan 436 by determining what schedule will be the most cost effective.

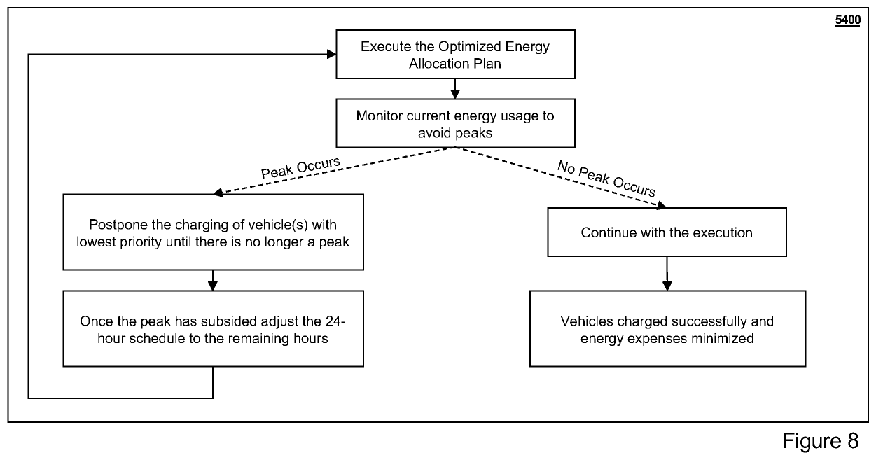

The hidden layers that perform the execution of the Optimised Energy Allocation Plan may follow a flowchart-style execution similar to that of a decision tree approach, as seen in FIG. 8, in accordance with one embodiment. Using the predicted energy usage data of the plan and the real-time facility energy usage data, the Optimisation Algorithm monitors the energy usage to avoid unnecessary peaks. This format allows for the continuous execution of the optimal plan and then accounts for what to do when there are unprecedented peaks that arise.

Using the combination of decision-tree, neural network, and predictive modelling approaches the Optimisation Algorithm successfully performs the given tasks and produces the three outputs as expected: a Predicted Energy Profile 432, an Optimised Schedule also known as the Optimised Energy Allocation Plan 436, and then the real-time execution of the plan 438.

### Use Case #3 Varying Rate of Charge

By way of a third example of a charging scenario, and with reference to FIG. 9, the Engine 020 enables a facility manager or fleet manager to optimise and execute on charge scheduling while actively balancing the facility load. It enables this by determining the active charging needs (through energy profiling and load priority of facility assets), determines the optimised usage to balance the facility load based on varying rate charges, and executes on the energy allocation plan.

In this exemplary implementation, the user, which might be the Facility or fleet manager, needs to optimise electric vehicle fleet charging to lower facility electricity spend without stopping fleet charging completely 500. When initiated, various data inputs are sent to the Engine 020. These inputs include Facility Energy data 602, Fleet Data 604, Charge station data 606, and EV360 Determined Data 608. Next, the Engine 020 utilises the data sent 600 to perform the following tasks of active charging optimisation 630. The Engine 020 determines the facility's energy profile 632 using past data to create a predictive model of tomorrow's energy needs that outlines possible peaks throughout the day. Next it will determine load priority within the facility 634 and flag loads that need priority over electric vehicle charging such as facility machines, or lighting. The Engine 020 calculates optimised variable rate charging plan 636 to balance facility load 646. By understanding daily facility energy profile, utility priority and tomorrow's charging needs 608 the Engine 020 calculates whether to vary the rate of charge and at what times to balance facility energy load and achieve tomorrow's charging needs 608, and enables the calculated recommendation.

With the implementation of charging communication protocols such as OCPP and OSCP the Engine 020 receives and transmits both data and control to the charging stations, meaning the Engine 020 may control each charging station to turn the station on and off, according to the optimal charge window. Additionally, certain charge stations with modern technology may limit the rate of charge delivered to the vehicle by a current limiting device or current limiting process. The rate of charge may be varied and programmed from 0% to 100% allowing for variable charging rates. This means charging vehicles at different charge rates will reduce the instantaneous energy demand on the facility, in accordance with some embodiments.

With this optimised variable rate charging plan 636 and the understanding of the daily facility energy profile 632 and load priority 634, the Engine 020 calculates a timeframe when the vehicles may not be charged due to other facility equipment or utilities that have a higher priority than that of the vehicle charging. Using this timeframe the Engine 020 may also determine when the vehicles may be charged and may also determine when there is excess facility energy so the vehicles may be charged at a lower rate. Cross-referencing these timeframes with the optimised variable rate charging plan 636 will result in the optimal variable rate charge windows, in which the Engine 020 charges the vehicles based on their charge priority and individual schedules via charging station protocols such as OCPP/OSCP. It will charge at a lower rate given the excess energy until the timeframe where the facility equipment and utilities are no longer using energy and then the vehicle charging will resume at full capacity.

For example, facility equipment might use the most energy and be flagged as priority between 9 am-5 pm so the optimised variable rate charging plan 636 would only charge the fleet at that time with any excess energy available. The Engine 020 may execute the optimised variable rate charging plan 636 by connecting to the charge station through OCPP/OSCP; it may turn individual or multiple groups of charging stations on and off, as well as change the charging rate to compliment the amount of available energy. Using the optimised variable rate charging plan 636, the Engine 020 charges the vehicles based on factors such as but not limited to their charge priority, individual schedules, and available energy (via OCPP/OSCP) to meet tomorrow's charging needs 608.

### Optimiser Engine Application (Use Case #3)

The following example is a description of how the Optimisation Algorithm relates to the third example. It should be appreciated that different types of algorithms may be implemented, and each may be used to perform their respective tasks. The combination of the techniques or algorithms work to provide the specific outputs as needed.

The first step this exemplary Optimisation Algorithm takes is to determine the features and what each of the inputs will be used for. Given the tasks that the Optimisation Algorithm is expected to conduct, it may be determined that there is one primary output that may be determined: an Optimised Charging Rates Plan which more optimally adjusts the Optimised Energy Allocation Plan (curated in Use Case #2) to accompany charging stations with varying charging rates.

Optimised Charging Rates Plan features, in this exemplary embodiment, include an Optimised Energy Allocation Plan, charging station type and rate, a list of prioritized facility energy loads or utilities (to come from a manual input), vehicle charging priority, real-time facility energy profile or usage data, and real-time vehicle battery states.

The hidden layers that curate the Optimised Charging Rates Plan may use the existing Optimised Energy Allocation Plan as a basic structure and the list of features above as external inputs. The first step the Engine 020 takes is determining where there may be small gaps between the estimated energy usage and the on-peak threshold that may be too large to charge a vehicle with the full charging power of a charging station. By determining the vehicle with the highest Charging Priority (as per described in Use Case #1), the Optimised Charging Rates Plan then allows a station with a variable rate of charge to use the remaining energy to begin charging the vehicle at a slower rate.

In the case that there is enough extra energy, multiple stations may be activated at either full or varied charging capacity to decrease the charging need throughout the remaining periods of the day. In the event that there is even more energy in real-time than estimated the charging rates may be adjusted accordingly to optimise the charging time further.

In the event that an unexpected peak occurs or a facility load or utility with higher priority is switched on then the charging rates may be lowered (and potentially completely shut off) until the peak subsides and then the Optimised Energy Allocation Plan will readjust and the Optimised Charging Rates Plan may execute once again.

### Use Case #4 Avoid Time of Use Penalties

By way of a fourth example for a charging scenario, and with reference to FIG. 10 the Engine 020 enables a facility manager or fleet manager to optimise and execute on charge scheduling while avoiding time of use charges. It enables this by determining the optimal charging window through use of energy profiling, time of use cost information, and cost saving analysis, and executes on the energy allocation plan. In addition, in this scenario a comparative cost saving analysis may be done and provided to a user, or automatically implemented within a facility.

In this implementation, the user, which may be the Facility manager, wishes to avoid high energy costs during defined or triggered Time of Use periods 700. Data is sent to the Engine 020. In this exemplary embodiment, this data includes Facility Energy Data 802, Fleet data 804, Charge Station Data 806 and EV360 determined data 808. With these inputs the Engine 020 performs the following task 830. The Engine 020 will determine an optimal charge window 832 using facility energy profile 802, tomorrow's charging needs 808 and Time of Use cost information 802. The Engine 020 will then determine the correct time window to charge the EV fleet to avoid Time of Use high-cost periods.

For example, energy from the grid may be more expensive when fleet first arrives at the facility between 6-9 pm, but cheaper from 9 pm-6 am so the cheaper time will be the determined optimal charge window. The Engine 020 will then execute the optimal charge plan 834. By connecting to charge stations through protocols such as OCPP it may turn on charging during the determined optimal charge window and charge to meet tomorrow's charging needs 808. Upon user request, the Engine 020 may then provide a comparative cost saving analysis 836 by calculating and comparing the cost of charging the EV during Time of Use periods vs. during optimal charge window.

### Optimiser Engine Application (Use Case #4)

The following example is a description of how the Optimisation Algorithm relates to the fourth example. It should be appreciated that different types of algorithms may be implemented, and that each may be used to perform their respective tasks. The combination of the techniques or algorithms work to provide the specific outputs as needed.

In this exemplary embodiment, the first step the Optimisation Algorithm takes is to determine the features and what each of the inputs will be used for. Given the tasks that the Optimisation Engine 020 is expected to conduct, it may be determined that there is one primary output: determine an Optimal Charging Window and then execute the Optimised Energy Allocation Plan (curated in Use Case #2) during the Optimal Charging Window. This is to minimize excess Time of Use during higher energy cost periods. Additionally the Engine 020 may conduct a comparative cost savings analysis during which it may compare the price of charging during the Optimal Charge Window versus during periods where energy costs are higher.

Optimal Charging Window features may include, but are not limited to, an Optimised Energy Allocation Plan, and a predicted Energy Profile.

The hidden layers that determine the Optimal Charging Window use the existing Optimised Energy Allocation Plan as a basic structure and the Predicted Energy Profile to determine periods of higher energy usage which correspond to higher energy costs. The Engine 020 thus takes the total time it takes to charge the vehicles and determines when the lowest energy usage for that period of time is. This is determined to be the Optimal Charging Window, in accordance with one embodiment.

Using the Predicted Energy Profile (which is based on previous energy data) the Engine 020 may determine what the predicted energy price may be over the course of the day. This is then used to calculate the charging price (given how much energy it will take to charge the vehicles) during the Optimal Charging Window and other time periods throughout the day. Using the figures the Engine 020 may then conduct a cost savings analysis and determine how much may be saved by charging during the Optimal Charging Window.

This exemplary method uses a Neural-Network approach to consider multiple schedule possibilities and finally compare their costs to determine the Optimal Charging Window.

### Use Case #5 Avoid Peak Demand Penalties

By way of a fifth example of a charging scenario, and with reference to FIG. 11, the Engine 020 may enable a facility manager or fleet manager to optimise and execute on charge scheduling while avoiding peak demand penalties. It enables this by determining charging schedule through facility energy usage, determining energy use reallocation scenarios or recommendations based on peak demand or other charge penalty related data, and executes on the energy allocation plan that takes into account peak demand penalties.

In this implementation, the user, which may be the Facility manager, wishes to avoid peak demand penalties 900. Data is sent to the Engine 020. This data includes Facility Energy Data 1002, Fleet data 1004, Charge Station Data 1006 and EV360 determined data 1008. With these inputs 1000 the Engine 020 performs the following task 1030. First it will understand the current facility energy profile 1032. Using current facility energy usage 1002 the Engine 020 will constantly know how much energy the facility is using. The Engine 020 will then determine the charge reallocation schedule 1034. Using current facility energy profile 1002 and tomorrow charging needs 1008 the Engine 020 may determine if the EV fleet should be charging or not and perform emergency scheduling to avoid unexpected peaks and shut off or slow down the rate of charge so a new peak is not set.

The system utilises a predictive method which analyzes the trends in past facility energy profiles to estimate the energy consumption peaks throughout the day. These peak demand predictions may help determine the charging schedule and pair with the daily facility energy profile to help determine an optimised charging schedule.

For example, if an event occurs and the facility is close to setting a new Peak, fleet charging will stop and be reallocated to another time slot in the day. The Engine 020 will execute a charge reallocation schedule 1036 by connecting to charge stations through OCPP to turn off EV chargers to avoid peaks and turn them on when the peak demand charge is no longer a concern, in order to meet tomorrow's charging needs.

### Optimiser Engine Application (Use Case #5)

The following example is a description of how the Optimisation Algorithm relates to the fifth example. It should be appreciated that different types of algorithms may be implemented, as each may be used to perform their respective tasks. The combination of the techniques or algorithms work to provide the specific outputs as needed.

The first step the Engine 020 takes is to determine the features and what each of the inputs will be used for. Given the task that the Optimisation Engine 020 is expected to conduct, it may be determined that there is one primary purpose: determine a Charge Reallocation Plan to be executed in the event that an unexpected peak occurs to avoid peak demand penalties.

Charge Reallocation Plan features may include, without limitation, an Optimised Energy Allocation Plan, an Optimised Charging Rates Plan, and Real-time facility energy profile or usage data.

The hidden layers that determine the Charge Reallocation Plan use the existing Optimised Energy Allocation Plan (Use Case #2) and the Optimised Charging Rates Plan (Use Case #3) as the standard input features. The Engine 020 may be executing the Optimised Energy Allocation Plan or the Charging Rates Plan (should the charging station allow transfer of the data or information) when the real-time energy usage data detects an unexpected peak. The algorithm uses a Decision-Tree method to determine how to proceed.

In the case that the charging stations have the capable technologies for variable rate charging and may be executing the Optimised Charging Rates Plan, the Charge Reallocation Plan may begin by lowering the charging rates of vehicles with lowest priority until the peak is subdued. The Engine 020 then continues to monitor the situation and adjusts the charging rates accordingly (which may either increase or decrease). Once the unexpected energy surge subsides the Optimisation Engine 020 will re-evaluate and execute the Optimised Charging Rates Plan anew.

In the case that the charging stations do not have sufficiently advanced or appropriate technology for variable rate charging, and may therefore not execute the Optimised Charging Rates Plan, the Charge Reallocation Plan may begin by halting the charging of vehicles with the lowest priority until the peak is subdued. The Engine 020 then continues to monitor the situation and turn stations on and off according to the amount of available energy. Once the unexpected energy surge subsides the Optimisation Engine 020 will re-evaluate and execute the Optimised Energy Allocation Plan anew.

### Use Case #6 Utility Feed Hybrid Selection to Reduce Cost

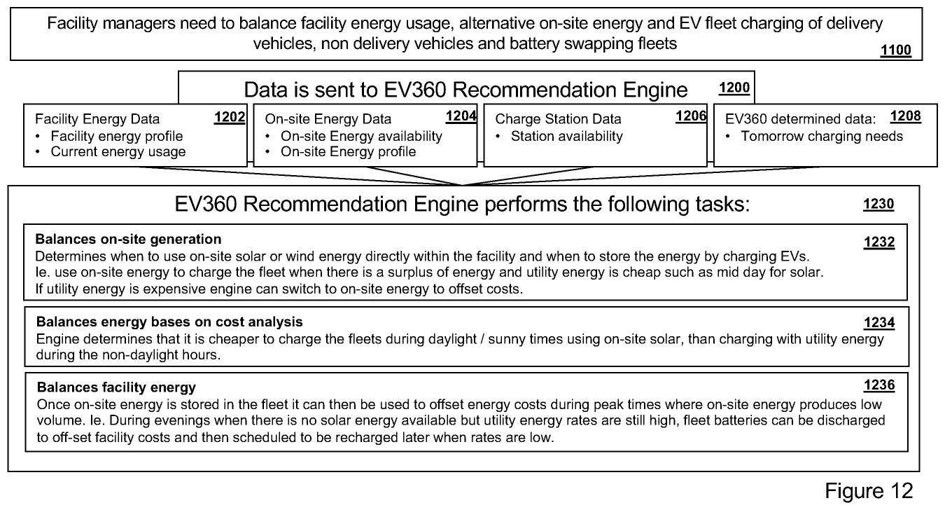

By way of a sixth example of a charging scenario, and with reference to FIG. 12, the Engine 020 enables a facility manager or fleet manager to optimise and execute on charge scheduling using a hybrid approach to energy management for the facility and fleet. It enables this by utilising onsite generation as part of the energy cost and charging calculations and operations, determining an alternate use of energy use based on costs of energy generation and use, and then reducing overall costs of facility or fleet management.

In this exemplary implementation, the user which might be the Facility manager in charge of facility operation may use the Engine 020 to balance and manage facility energy use, alternative on-site energy and EV fleet charging of delivery vehicles, non-delivery vehicles, or even battery swapping fleets 1100. When initiated, various data inputs are sent to the Engine 020. These inputs 1200 include Facility energy data 1202, On-site Energy data 1204, Charge Station Data 1206, and EV360 determined data 1208. Next the Engine 020 utilises the data 1200 to perform the following tasks 1230. The Engine 020 will balance on-site generation 1232 and determine when to use on-site solar or wind or other alternative energy directly within the facility and to store the energy by charging the electric vehicles or using battery energy storage systems based on utility rate, predicted facility energy profile 1202, onsite energy availability 1204, and tomorrow's charging needs 1208.

For example, the Engine 020 might use on-site energy to charge the electric vehicle fleet when there is a surplus of on-site energy and utility energy is cheap, such as midday for solar energy. If utility energy is at a cost above the threshold the facility manager wishes to pay, the Engine 020 may switch to on-site energy to offset facility energy costs and reschedule fleet charging for when utility energy is less expensive to still achieve tomorrow's determined charging needs 1208. The Engine 020 balances energy based on cost analysis 1234. It utilises utility rates, predicted facility energy profile 1202, and onsite energy availability 1204 to calculate whether it is cheaper to charge the fleets during the day using on-site energy or to charge during the night using utility energy, and then operationalizes the recommendation or action to balance using the hybrid approach.

In accordance with another embodiment, another implementation describes how the Engine 020 determines whether to use on-site energy to offset the current energy prices and to accordingly charge later or to charge immediately. If energy prices are higher during the day the Engine 020 will reschedule charging for later in the night when utility and energy prices are much lower. The decision would be made using a predictive cost analysis that compares the prices of charging the vehicle(s) immediately or waiting until the energy prices drop and charging during the cheapest window.

Alternatively, other energy sources such as wind or solar may be compared as well. When alternative energy sources are being generated on-site the Engine 020 may determine the cost of charging the vehicle(s) using non-grid-based energy and compare it with that of the grid energy.

Energy may also be stored temporarily in the vehicle batteries to act as storage and may be discharged back to the grid and used to offset energy costs during peak load times. For example, during peak times such as evening when there is no solar energy available but utility energy rates are high, fleet batteries may be discharged to offset facility energy cost then rescheduled to be recharged later when rates are low to still achieve tomorrow's determined charging needs 1208.

The Engine 020 may then balance the facility energy outputs 1236 using a combination of the temporary energy storage, the on-site energy balancing, and the predictive cost analysis between immediate charging and charging during the optimum charge window per lowest energy cost.

### Optimiser Engine Application (Use Case #6)

In accordance with one embodiment, the following example is a description of how an Optimisation Algorithm relates to the sixth example. It should be appreciated that different types of processes may be implemented, wherein each may be used to perform their respective tasks. The combination of the techniques or algorithms work to provide the specific outputs as needed.

The first step the Optimisation Algorithm takes is to determine the features and what each of the inputs will be used for. Given the task that the Optimisation Engine 020 is expected to conduct, it may be determined that there are two primary purposes, in accordance with one embodiment: to balance the generation of on-site energy sources, and to determine the most cost-effective energy source when managing both on-site and grid energy throughout the day.

In this embodiment, the first step the Engine 020 takes is to determine the features and what each of the inputs will be used for. This example contains three intermediate algorithms that focus on: determining when to use and store on-site energy, determining the most cost-effective way to use on-site energy, and balancing both on-site and grid energy sources to offset energy peaks. Non-limiting examples of the features for these intermediate processes may include:
1. On-site Energy Generation features:
   On-site energy sources
   On-site energy source profiles
   Real-time vehicle battery states
   Predicted Energy Profile
   Real-time facility energy profile or usage data
2. Cost Effective Energy Sourcing features:
   On-site Energy Generation
   Predicted Energy Profile
   Optimal Charging Window
3. Real-time Energy Source Balancing features:
   Cost Effective Energy Sourcing
   Predicted Energy Profile
   Real-time facility energy profile or usage data
   Real-time vehicle battery states

The hidden layers that the Engine 020 uses to manage the On-site Energy Generation determine when to use alternative on-site energy sources to power the facility directly and when to store on-site generated energy for later use. During on-peak energy periods when grid energy is more expensive the Optimisation Engine 020 may use available on-site energy generation to supplement energy past the threshold to avoid on-peak grid energy costs. When grid energy is not being charged at an on-peak premium then the Optimisation Engine 020 uses on-site generated energy to directly charge vehicles. This may be used as either temporary energy storage in the vehicle batteries or replace the need for vehicle charging later.

In one embodiment, the hidden layers that perform the Cost-Effective Energy Sourcing may use a comparative Neural-Network-like or similar approach in which the Engine 020 determines the optimal energy source during the Optimal Charging Window. Using the Predicted Energy Profile the Optimisation Engine 020 adapts the Optimised Charge Allocation Plan (or Optimised Charging Rates Plan should it be executing and the charging station permits) to the chosen energy source.

The hidden layers of the Real-time Energy source Balancing use the Cost-Effective Energy Sourcing to charge vehicles and store excess energy. Using the Predicted Energy Profile, the Engine 020 then determines when there are peak periods and may discharge the excess vehicle charge to lower facility energy costs. The Optimisation Engine 020 may then monitor the vehicle battery states to ensure that there remains enough charge to carry out the following day's schedule or may re-execute the Optimised Charge Allocation Plan (or Optimised Charging Rates Plan should it be executing and the charging station permits) once the energy rates have lowered.

### Use Case #7 Charge Station Allocation Plan

By way of a seventh example for a charging scenario, and with reference now to FIG. 13, the Engine 020 may enable a facility manager or fleet manager to optimise and execute on charge station scheduling to allow for optimised charging of EV fleets based on parking locations. This may also be used for autonomous vehicles or autonomous robots, reducing overall costs of facility or fleet management. It enables this charging scenario by determining priority of individual or groups of vehicles, and then determining a parking plan based on a priority of the vehicles, where the charging station voltage (and thus impacting corresponding energy use and/or cost) may vary. For fleet managers requiring a fast, high voltage charge of vehicles, this charging scenario allows for an alternate implementation to address organized parking which also enables various charge capacities. It may also be used where in the charging station enables battery exchanges for the vehicle or robot in question, so the vehicle or robot may “swap the battery and go” with a newly charged battery, and the remaining depleted (or partially depleted) battery is managed using the same process.

In this implementation, the users, which might be the fleet managers or electric vehicle drivers, or fully autonomous electric vehicles themselves, are in need of a method of organized parking and charge station allocation plan 1300. This could apply to the allocation of chargers that charge at different rates such as level 1, 2, or 3 chargers, or facilities that have more EVs than charge stations but still need to charge each vehicle. When initiated data is communicated to the Engine 020. This data includes data such as individual EV data 1402, Fleet data 1404, Charge station data 1406, and EV360 determined data 1408. In one embodiment, the Engine 020 may then use this data to calculate and perform the following tasks 1430: it first determines the priority vehicle 1432 based on fleet data 1404, vehicle data 1402, and tomorrow's charging needs 1408; once the charging needs of each individual vehicle are calculated, EV360 will determine a charging order for the vehicles and begin charging based on the vehicle with the highest priority; and determine priority 1434 based on, for example, the amount each vehicle needs to charge, and tomorrow's departure time.

Each charging amount is determined given the difference between existing battery state and necessary battery state for tomorrow's route (outlined above) with the addition of a safety buffer charge (to compensate for miscellaneous obstacles such as traffic, time the vehicle is left running during the actual delivery, etc.). This value for the safety buffer may be changed by the fleet manager, however a buffer of, for example 5%, may be set to be included in the Engine 020 charging calculations. The vehicles that need to charge more will have a higher priority than those who do not need to charge as much or at all in order to avoid Time of Use and/or Peak demand or any other penalties, restrictions, and/or boundaries given by the Grid Data or manual inputs.

Scheduled departure time may be determined by the delivery time of the vehicle's first order, typically the following day. Using a route planning service, the Engine 020 calculates the latest time the vehicle will need to depart in order to complete the task on time, which enables the facility manager or fleet manager to plan departure times that maximize the charging efficiency of the fleet. The vehicles that will need to leave earlier will have a higher priority than those whose departure times are later.

For example, if Vehicle A has the earliest departure time of the vehicle fleet and needs a full charge before its departure, it would be highlighted as a priority vehicle. Next, a parking plan and charge station allocation plan 1434 will be determined based on charge station data 1406 and priority determined vehicles 1432 and tomorrow's charging needs 1408.

For example, the Engine 020 may then determine that Vehicle A should be parked in a Charge Station with a level 2 charger for a faster rate of charge in order to meet tomorrow's charging needs 1408 and early departure time. If a facility has less charge station than electric vehicles but still needs to charge each EV, The Engine 020 may then determine a Parking Time Interval plan 1438. This could apply to both autonomous and non-autonomous fleets. The Engine 020 would determine where each vehicle should park and the time interval at which they should park in order to meet tomorrow's charging needs 1408 and charge the entire fleet with the possibly limited amount of charge stations.

For example, if Vehicles A and B both need 6 hours of charge but only have one charge station available, the determined plan would be that Vehicle A should park at the charge station at the end of the day to be charge from 6 pm-12 am while Vehicle B should park at the non-charging spot and wait to move into the charging station from 12 am-6 am. The Engine 020 would then send the parking plan directly to the autonomous vehicle or driver or to the fleet manager 1438.

### Use Case #8 V2B Response

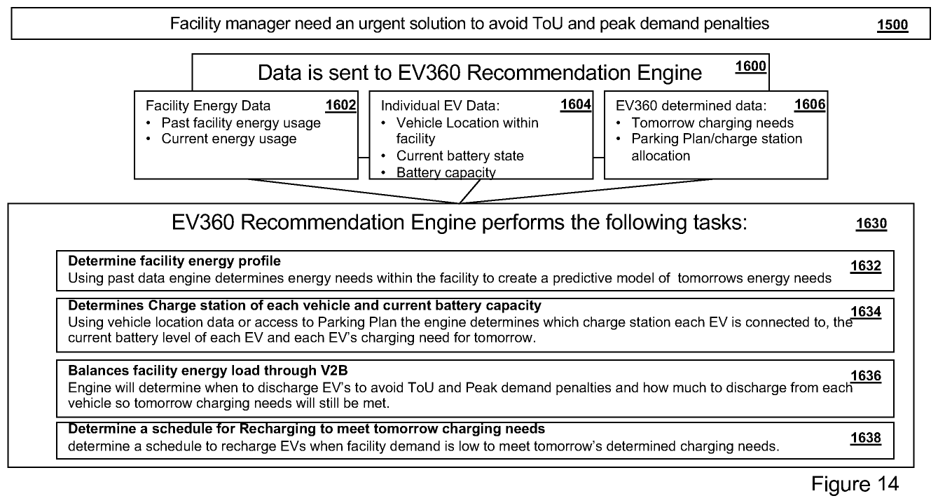

By way of an eighth example and corresponding charging scenario, and with reference to FIG. 14, the Engine 020 enables a facility manager or fleet manager to avoid time of use or peak demand penalties using a V2B (Vehicle to Building) energy management approach. It enables this by discharging needed energy from EV's not in use for facility use, to reduce peak demand or time of use penalties, based on current need as well as forecasted need and energy cost in the future.

In this implementation, the user, which might be the facility manager, needs a time-sensitive solution to offset energy usage within a facility or geographically spread entity to possibly avoid Time of Use or Peak Demand penalties 1500. When initiated data is sent to the Engine 020. This data includes Facility Energy data 1602, individual EV data 1604, and EV360 determined data 1406. Next the Engine 020 uses this data to perform the following tasks 1630, in accordance with one exemplary embodiment. It will determine the facility's energy profile 1632 using past data to determine energy needs within the facility or geographically spread entity to create a predictive model of future energy needs including possible peaks and downtimes. Next it will determine the charge station of each vehicle and the current battery capacity 1634. It will achieve this by using vehicle location data which may include access to the EV Parking Plan or charge station information. The Engine 020 determines the location and charge station of each EV, the current battery level of each EV, and the charging needs for tomorrow 1606, and based on this calculates an optimisation plan. In more detail, the Engine 020 follows the optimised vehicle charging plan combined with the parking time interval plan to determine when and where each vehicle will be charged, including how long each of the vehicles must be charged. When the facility nears a peak or energy demand spikes the Engine 020 will then balance the facility's energy load through Vehicle to building bidirectional charging 1636. It determines when to discharge the EV's to avoid ToU and Peak demand penalties and how much to discharge from each vehicle so tomorrow's charging needs 1606 will still be met. The Engine 020 issues instructions to alter current charging schedule, and schedule a recharging to meet tomorrow's charging needs 1636. This method ensures that the facility operators or external clients are not charged more for energy during on-peak hours and may actually discharge stored energy back to the facility from the vehicle's batteries to avoid peak demand or Time of Use penalties.

It should also be considered that the Engine 020 makes a calculation on whether to take action in the V2B scenario depending on if the future charging needs will be met or not. For example, the user won't want to save money on a ToU offset if that makes it so his fleet isn't fully charged for tomorrow's deliveries as it may be deemed more critical to have at least a portion of the fleet fully charged in specific circumstances.

### Use Case #9 Overcharge Sold Back to the Grid During Peaks (V2G)

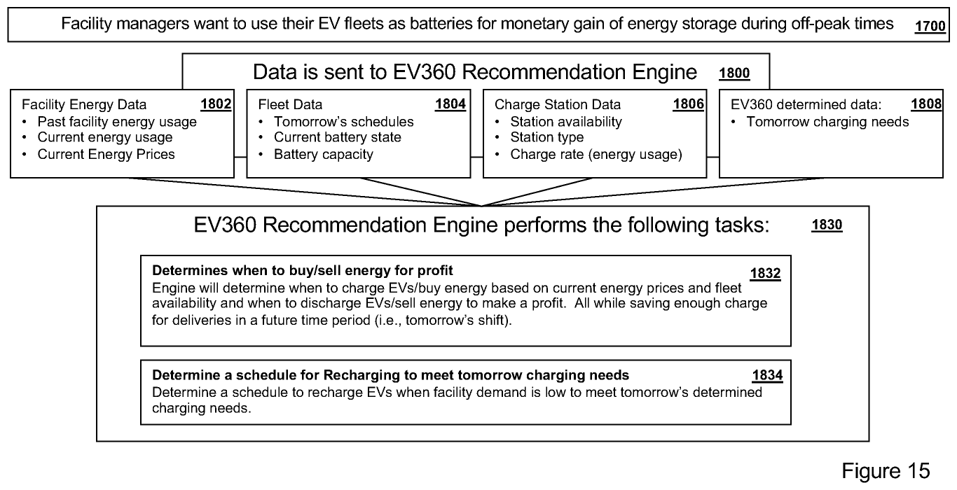

By way of a ninth example and charging scenario, and with reference to FIG. 15, the Engine 020 enables a facility manager or fleet manager to sell overcharge energy back to the energy grid via Vehicle-Grid (V2G) energy management approach. It enables this by charging EV during off-peak times to store energy and discharging energy from EV's back into the energy during peak times for a profit.

In this implementation, the user, which might be the facility or fleet manager, may use their EV fleets as batteries for monetary gain of energy storage during off-peak times 1700. When initiated data is sent to the Engine 020. These inputs, in one embodiment, may include: Facility Energy data 1802, Fleet data 1804, Charge station data 1806, and EV360 determined data 1408. The Engine 020 may use this data to perform the following tasks 1830, in accordance with one embodiment.

The engine 020 will determine when to buy or sell energy for optimal profit 1832. The Engine 020 will determine when to charge EVs/buy energy based on current energy prices 1802 and fleet availability, and determine when to discharge EV/sell the energy back to the energy grid to make a profit while still allocating enough time to recharge the EV fleet to meet tomorrow's charging needs 1808. The Engine 020 will then determine a schedule for recharging to meet tomorrow's charging needs 1834.

For example, some of the EV fleet are not being used for delivery during the day but will be used the following day. The Engine 020 would determine that these EVs may be used to sell overcharge energy and will charge the EV when energy prices are the lowest throughout the day based on a predicted or given model of the daily energy prices and ToU rates. EVs may be discharged during peak time via vehicle-to-grid bidirectional charging to make a profit from the energy sold back to the grid. This would only happen if the Engine 020 determines that there is enough allotted time to recharge the EV fleet to achieve tomorrow's charging needs, in accordance with one embodiment.

An alternative method in which this technique could be employed would be charging vehicle batteries to full during off-peak hours when the energy prices are low and then using the batteries as an energy storage space. This stored energy may be sold back to the grid during on-peak hours or when the energy prices spike again meaning the client makes more profit than they would have originally spent on charging the vehicles.

### Optimiser Engine Application (Use Case #9)

The following example is a description of how an exemplary Optimisation Algorithm may relate to the ninth example. It should be appreciated that different types of processes may be implemented, and that each may be used to perform their respective tasks. The combination of the techniques or algorithms work to provide the specific outputs as needed.

In one embodiment, the first step the Optimisation Algorithm may take is to determine the features and what each of the inputs will be used for. Given the task that the Optimisation Engine 020 is expected to conduct, it may be determined that there are two primary purposes: to determine how to react when met with a demand response event and to determine how to recharge follow up a demand response event so that the vehicles meet tomorrow's charging needs.

In the instance that a demand response event is triggered, whether for monetary benefit or contractual obligation, the Engine 020 may implement several smaller algorithms that break the task down and work cohesively to minimize error. This example contains three intermediate algorithms that focus on: using the Predicted Energy Profile to determine when to interact with the grid energy source, how to interact with it, and the following measures to ensure the vehicles are charged for their next route. The features for these intermediate algorithms may include, but are not limited to:
1. Predicted Energy Prices features:
   Predicted Energy Profile
2. Buy and Sell System features:
   Predicted Energy Prices
   Real-time vehicle battery states
3. Vehicle Recharging features:
   Real-time vehicle battery states
   Optimised Energy Allocation Plan
   Optimised Charging Rates Plan

The hidden layers that determine the Predicted Energy Prices analyze the trends in the Predicted Energy Profile. Using the Predicted Energy Profile (which is based on previous energy data) the Engine 020 may determine what the predicted energy price may be over the course of the day given by on-peak time periods where energy will be more expensive and off-peak periods where it will be much cheaper. Once the Optimisation Engine 020 has predicted the energy prices it may begin to prepare all of the remaining energy storage spaces in the vehicle batteries to be filled during the off-peak hours.

The hidden layers that determine the workings of the Buy and Sell System during the demand response use both the Predicted Energy Prices and the real-time vehicle battery states as features. When the energy prices are lower the Engine 020 may purchase excess energy from the grid and charge the vehicle batteries as much as possible and when the prices go up the Optimisation Engine 020 may sell the excess energy back to the grid for a profit. This may also halt charging since energy prices are incredibly high and it is much more cost efficient to wait until the peaks subside and the demand response event is over. If the profit margin is particularly large the Engine 020 may decide to oversell energy meaning that the vehicles may not be fully charged for their next departure.

The hidden layers that determine the Vehicle Recharging first measure the new battery states of the vehicles. Then either the Optimised Charge Allocation Plan or the Optimised Charging Rates Plan (based on the available charging station technology) is executed to ensure that the vehicles have enough battery charge to complete their routes by departure time.

### Use Case #10 Participation in Demand Response Programs

By way of a tenth example and charging scenario, and with reference to FIG. 16, the Engine 020 enables a facility manager or fleet manager to participate in Demand Response programs with the energy grid via Vehicle-to-Grid (V2G) and other energy management approaches. It enables this by discharging energy from the EV's back into the energy grid and load shedding within the facility to achieve desired Demand Response or other energy related demand requests.

In this implementation, the user, which might be the facility or fleet manager, wants to participate in Demand Response programs for monetary gain or contractual obligation 1900. When initiated data is sent to the Engine 020. This data includes Facility Energy data 2002, Fleet data 2004, Charge station data 2006, Grid data 2007 and EV360 determined data 2008. Next the Engine 020 uses this data 2000 to perform the following tasks 2030. It will determine the facility's energy profile 2032 using past facility energy data 2002 to determine energy needs within the facility or geographically spread entity to create a predictive model of tomorrow's energy needs including possible peaks and downtimes.

When asked to participate in a Demand Response event the Engine 020 will determine whether to shed load by stopping charging of the EV fleet or discharge the fleet through bidirectional charging back to the grid. Additionally, the Engine 020 will decide to opt out of the Demand Response event if the vehicles may not be discharged and recharged quick enough to allot for tomorrow's schedule and charging needs 2034.

If participating in a Demand Response event the Engine 020 adjusts the charging schedule to compensate for the extra energy that is being shed now and also determine if there will be enough time and resources to recharge following the event. It will then create an optimised charging schedule to meet tomorrow's charging needs 2008 or adjust the charging schedule to fit the new changes the Demand Response event triggered.

### Optimiser Engine Application (Use Case #10)

The following example is a description of how the Optimisation Algorithm relates to the tenth example, in accordance with one exemplary embodiment. It should be appreciated that different types of processes may be implemented, and that each may be used to perform their respective tasks. The combination of the techniques or algorithms work to provide the specific outputs as needed.

In one embodiment, the first step the Optimisation Algorithm takes is to determine the features and what each of the inputs will be used for. Given the task that the Optimisation Engine 020 is expected to conduct, it may be determined that there are two primary purposes: determine how to react when met with a demand response event and determine how to recharge follow up a demand response event so that the vehicles meet tomorrow's charging needs.

In the instance that a demand response event is triggered, whether for monetary benefit or contractual obligation, the Engine 020 may implement several smaller algorithms that break the task down and work cohesively to minimize error. This example contains three intermediate algorithms that focus on: using the Predicted Energy Profile to determine when to interact with the grid energy source, how to interact with it, and the following measures to ensure the vehicles are charged for their next route. The features for these intermediate algorithms may be listed as follows, in accordance with one embodiment:
1. Predicted Energy Prices features:
   Predicted Energy Profile
2. Buy and Sell System features:
   Predicted Energy Prices
   Real-time vehicle battery states
3. Vehicle Recharging features:
   Real-time vehicle battery states
   Optimised Energy Allocation Plan
   Optimised Charging Rates Plan

The hidden layers that determine the Predicted Energy Prices analyze the trends in the Predicted Energy Profile. Using the Predicted Energy Profile (which is based on previous energy data) the Engine 020 may determine what the predicted energy price may be over the course of the day given by on-peak time periods where energy will be more expensive and off-peak periods when it will be a lower price.

The hidden layers that determine the workings of the Buy and Sell System during the demand response use both the Predicted Energy Prices and the real-time vehicle battery states as features. When the energy prices are lower the Engine 020 may purchase excess energy from the grid and charge the vehicle batteries as much as possible and when the prices go up the Optimisation Engine 020 may sell the excess energy back to the grid for a profit. This may also halt charging since energy prices are incredibly high and it is much more cost efficient to wait until the peaks subside and the demand response event is over. If the profit margin is particularly large the Engine 020 may decide to oversell energy meaning that the vehicles may not be fully charged for their next departure.

Alternatively, if the case is that there is a contractual obligation rather than a financial one the intermediate algorithms would be the same. Once the Engine 020 determines how much the facility should discharge back to the grid and when it would be most cost-effective to charge the vehicles, the intermediate algorithms would be similarly followed.

The hidden layers that determine the Vehicle Recharging may first measure the new battery states of the vehicles, in accordance with one embodiment. Then either the Optimised Charge Allocation Plan or the Optimised Charging Rates Plan (based on the available charging station technology) is executed to ensure that the vehicles have enough battery charge to complete their routes by departure time.

### Use Case #11 Minimize Downtime for Multi-Charge Days

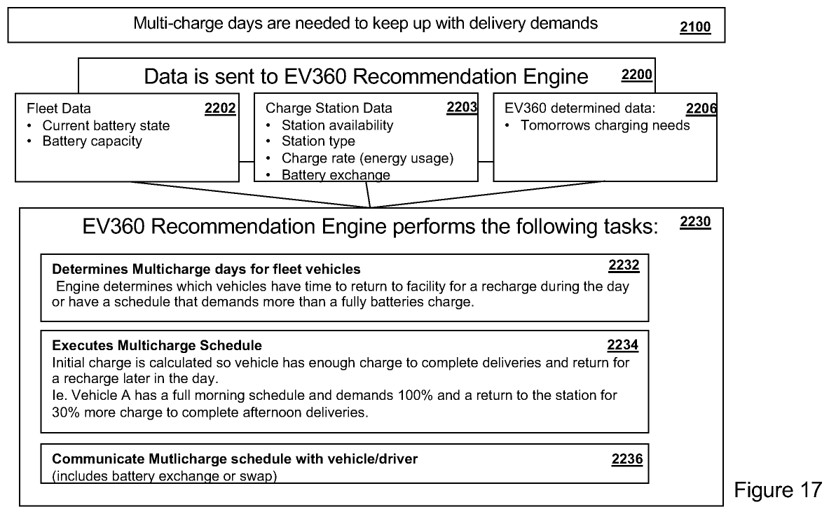

By way of an eleventh example, and with reference now to FIG. 17, the Engine 020 enables a facility manager or fleet manager to participate in multi-charge scheduled days to balance delivery demands and minimize downtime. It enables this by determining when a multiple charge day should occur according to delivery demands and charging availability.

In this implementation, the user, which might be the facility or fleet manager, wants to enable multi-charge days for vehicles to keep up with delivery demands 2100. When initiated, data is sent to the Engine 020. In one embodiment, this data includes Fleet data 2202, Charge station data 2203, and EV360 determined data 2006. The Engine 020 uses this data to perform the following tasks 2230: it will determine the need for multi-charge days for each fleet vehicle 2232; the Engine 020 will determine which vehicle has time to return to the facility for a second charge during the day or has a schedule that demands more than a full battery charge and highlights these vehicles as multi-charge days; and the Engine 020 will create and execute a multi-charge day schedule 2234.

For example, if Vehicle A has a full morning schedule and demands 100% charge and a return to the station for 30% more charge to complete afternoon delivery, the Engine 020 will determine what time that vehicle should return and how much more charge it needs to complete deliveries. It will then construct a schedule to accommodate for the second charge in the afternoon and place the charging period on an off-peak or a lower priced energy period (if possible) to save on energy expenses.

Similarly, the Engine 020 may plan multi-charge days to avoid ToU. For example, a Vehicle may only charge 50% last night because the Engine 020 determined it would be cheaper to return during the next day for a second charge than to charge all at once. The Engine 020 will then communicate its multi-charge schedule with the vehicle, driver or fleet manager 2236. The optimised charging plan will then be adjusted accordingly and the other vehicles prioritized since they will most likely not have to return for a second charge meaning there is less overall load to account for in the afternoon.

### Optimiser Engine Application (Use Case #11)

The following example is a description of how the Optimisation Algorithm relates to the eleventh example. It should be appreciated that different types of processes may be implemented, and that each may be used to perform their respective tasks. The combination of the techniques or algorithms work to provide the specific outputs as needed.

In one embodiment, the first step the Optimisation Algorithm takes is to determine the features and what each of the inputs will be used for. Given the task that the Optimisation Engine 020 is expected to conduct, it may be determined that there are two primary purposes: determine if multiple charges are required to complete the daily schedule and execute the Multi-charge Schedule if necessary. For this instance to take place the vehicle's schedule must account for multiple trips.

Once the vehicle returns from the preceding trip the battery state is measured and the Optimisation Engine 020 determines how much to charge the vehicle for the next route. The Engine 020 then determines when to charge the vehicle before its next trip and what method of charging to employ.

A possible method to minimize downtime for multi-charge days is to implement battery exchanges. This means charging a replacement battery at the facility (which may be counted as an extra vehicle with low priority) and having it ready so that when the vehicle returns to the facility during a multi-charge day the batteries may be swapped. This not only is more time efficient but also allows the backup battery to be charged whilst other vehicles are on-route and the charging energy is not being used.

### Use Case #12 On-Route Charging

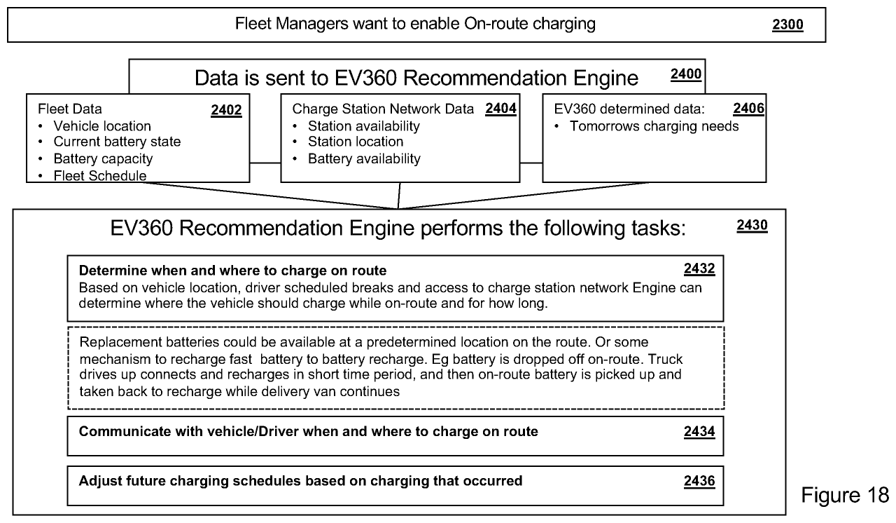

By way of a twelfth example, and with reference to FIG. 18, the Engine 020 enables a facility manager or fleet manager to participate in on-route charging to balance delivery demands and minimize downtime. It enables this by access to a charge station network and by determining when an on-route charge should occur according to delivery demands, workers schedules and charging availability.

In this implementation, the user, which might be the facility manager, wants to enable on-route charging 2300. When initiated data is sent to the Engine 020. This data includes Fleet data 2402, Charge station Network data 2404, and EV360 determined data 2406. Next the Engine 020 uses this data 2400 to perform the following tasks 2430. It will determine when and where to charge on route 2432. Based on vehicle location, driver scheduled breaks and access to charge station network and availability the Engine 020 may determine where each vehicle should charge while on-route and for how long. Next it will communicate with the vehicle or driver or fleet managers when and where each vehicle should charge 2434. The Engine 020 will then adjust future charging schedules based on charging that occurred 2436.

Additionally, there are external services that help with the battery estimations for routes such as Google Maps that will calculate how much battery a route will take and will also factor in any necessary charging stops along the way, along with re-calculating routes to include charging station stops. With the implementation of these external services the Engine 020 may calculate where and when vehicles may stop to recharge on-route.

Once these on-route adjustments are made the Engine 020 will adjust the optimised charging schedule upon the vehicle's return to the facility. One alternative opportunity that on-route charging presents is the ability for workers to charge vehicles at their homes (which would be a private network therefore the use of an external service would most likely be void), or on-route battery replacement in lieu of re-charging.

### Optimiser Engine Application (Use Case #12)

The following example is a description of how the Optimisation Algorithm relates to the twelfth example, in accordance with one embodiment. It should be appreciated that different types of processes may be implemented, and that each may be used to perform their respective tasks. The combination of the techniques, processes, or algorithms work to provide the specific outputs as needed.

In one embodiment, the first step the Optimisation Algorithm takes is to determine the features and what each of the inputs will be used for. Given the task that the Optimisation Engine 020 is expected to conduct, it may be determined that there are two primary purposes: determine an on-route charging schedule and plan the vehicle's schedule accordingly. For this embodiment, there may be an existing Charge Station Network with station availability data (e.g. schedule and location).

Based on the vehicle's route and battery state the Engine 020 may determine that the vehicle requires an on-route charge if the battery level will be insufficient to return to the facility or if the driver requires a scheduled break. In this case the route may be adjusted to account for the stop and the Necessary Charge Calculation may be conducted (Use Case #1) to determine how much charge is required. The vehicle may then be scheduled to stop at the on-route station until the battery is sufficiently charged to complete the route.

The vehicle may then require less charge once returned to the facility and once the battery state is measured then the Engine 020 will adjust its plan of action accordingly, whether it will affect future charging schedules or store extra energy to be sold back to the grid at a later point.

A possible method to minimize downtime at on-route charging stations is to implement battery exchanges. This means charging a replacement battery at the station or facility (which may be counted as an extra vehicle with low priority) and having it ready at the station so that when the vehicle stops for an on-route charge the batteries may be swapped. This not only is more time efficient but also allows the backup battery to be charged whilst other vehicles are on-route and the charging energy is not being used.

As an extension of this use-case, and in accordance with one embodiment, the on-route charging or charge station network may be extended to ensure use of the charge network is guaranteed, which may be critical if vehicles are charged to their minimum requirements and have little safety allocation for excess charge. In operation, the Engine 020 would reserve a charging spot at a designated charge station for the vehicle in question, ensuring the planned on-route charge can be accomplished. Further, on-route charging may dynamically be reserved and allocated to a vehicle that the Engine 020 recognizes needs additional charge due to upcoming route changes or other unplanned disruptions (i.e., vehicle may need re-routed to support another vehicle's delivery if there is a breakdown of the second vehicle). As part of the digital twin analysis, users perform what-if scenarios to ensure re-routed vehicles that need additional on-route charging also have charging stations that are available to perform the charges (and as well as the desired cost).

### Use Case #13 Vehicle-to-Vehicle Charge Sharing

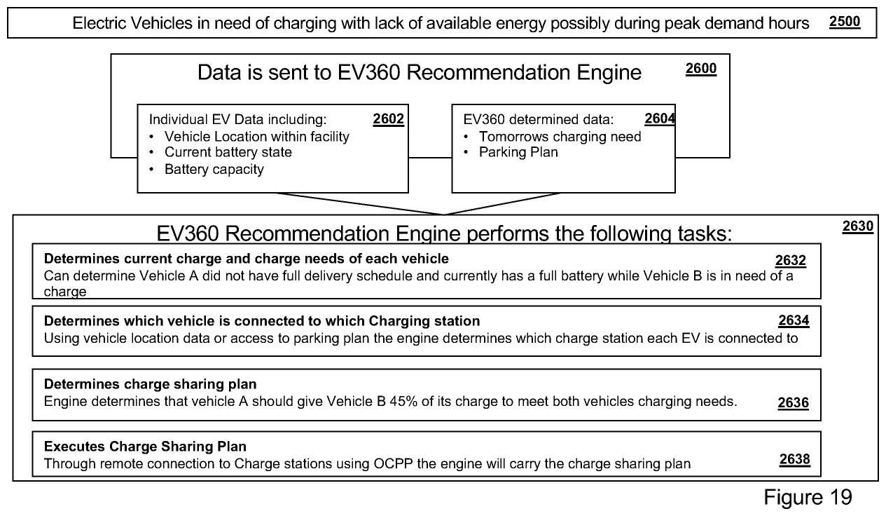

By way of a thirteenth example and charging scenario, and with reference to FIG. 19, the Engine 020 enables a facility manager or fleet manager to participate in vehicle-to-vehicle charge sharing to balance charge between vehicles. It enables this by vehicle-to-vehicle bidirectional charging and by determining an optimal charge sharing plan based on facility peaks and individual EV charging needs.

In this implementation, the user, which might be the facility manager, wants to enable vehicle-to-vehicle charging as a solution to the lack of available energy that might occur during peak demand hours 2500. In this exemplary embodiment, initiated data 2600 may be sent to the Engine 020, which may include data related to individual EV data 2602 and EV360 determined data 2604. Next the Engine 020 may use this data 2600 to perform the tasks 2630. It may determine the current charge and charge needs of each vehicle 2632, in accordance with some embodiments.

This method may be more time and cost effective during on-peak hours since there is no energy being bought from the grid, nor is there energy being actually used from the facility. The energy transfer between two vehicles independent of the facility or other utilities means that there are no additional charging costs. Once the charge transfer has been completed the Engine 020 may then assess the vehicles and determine if the remaining vehicles will need to be charged more from the facility or grid based on the minimum amount of charge each vehicle needs for their routes tomorrow.

For example, Vehicle A may not have had a full delivery schedule and currently has a full battery while Vehicle B is in need of a charge. First the Engine 020 will determine which vehicle is connected to which charging station 2634 using the vehicle location data 2602 or through accessing the Parking Plan 2604. The Engine 020 determines that Vehicle A should give Vehicle B 45% of its charge. Next it will execute the charge sharing plan 2636. By connecting to charge stations through protocols such as OCPP it may turn on V2V charging and commence the charge sharing plan. After the transfer is complete the Engine 020 will calculate whether the vehicles need to be charged anymore according to tomorrow's charging needs 2604 and will adjust the charging schedule to accommodate any changes.

### Optimiser Engine Application (Use Case #13)

The following example is a description of how the Optimisation Algorithm relates to the thirteenth example, in accordance with one embodiment. It should be appreciated that different types of processes may be implemented, and that each may be used to perform their respective tasks. The combination of the techniques or processes may work to provide specific outputs as needed.

The first step the Optimisation Algorithm takes, in one embodiment, is to determine the features and what each of the inputs will be used for. Given the task that the Optimisation Engine 020 is expected to conduct, it may be determined that there is one primary purpose: determine a Charge Sharing Plan to be executed in the event that a vehicle has excess charge and may be used as a power source to charge another vehicle.

To obtain the desired output there may be several smaller algorithms that break the task down into smaller tasks and work cohesively to minimize error. This first example contains two intermediate algorithms that focus on: determining how much extra charge each vehicle has and determining a Charge Sharing Plan that may be executed. The features for these intermediate algorithms may be listed as such, in accordance with one embodiment:
1. Excess Charge Calculation features:
   Necessary Charge Calculation
   Real-time vehicle battery states
2. Charge Sharing Plan features:
   Vehicle Charging Priority
   Necessary Charge Calculation
   Excess Charge Calculation
   Parking Plan
   Real-time vehicle battery states

The hidden layers that perform the Excess Charge Calculation may use the Necessary Charge Calculation value previously calculated (e.g. Use Case #1) and the real-time battery charge level. By measuring the current charge of the battery and subtracting the Necessary Charge value the Engine 020 determines the Excess Charge of a vehicle.

The hidden layers that determine the Charge Sharing Plan use the existing Excess Charge Calculation value of one vehicle and the Necessary Charge Calculation value of another. By calculating each of these for each vehicle the Engine 020 determines which vehicles are eligible to participate in the Charge Sharing Plan. In the case that there are two vehicles that may be able to share their charge the Parking Plan may be accessed to determine which vehicle to discharge and where to send the charge. Once the Optimisation Engine 020 has determined such, the Charge Sharing Plan may be executed with the vehicle with excess energy discharging some of its charge to the grid and it being subsequently sent to the other vehicle.

### Digital Twin

In accordance with various embodiment, digital twinning using the Engine 020 may allow a user to create an accurate operational model of the facility, the fleet (logistics and/or telematics), and the environment in which the fleet will be operating (e.g. roads or location over time, weather, traffic, or the like) to see the impact of recommendations or predicted optimisations. This allows the user to more accurately assess changes in operations across a complex system, and for the Engine 020, allow a user to see the financial and operational impacts of proposed changes. It may additionally or alternatively be used for other operational planning, such as running predictive maintenance forecasts, for example, running a new fleet use scenario, and/or to see how maintenance schedules of the fleet need to adapt to accommodate the changes.

While the Engine 020 may be enabled in near-real time or real time use, it may also be used for analysis of zones or sub-zones for any portion of the system (e.g. BMS/EMS 5010, Connectivity Charging & Monitoring 5020, Fleet Telematics & Planning 5030, such as GPS tracking and/or Delivery Management) that may interact with devices that require energy use (e.g. Energy related information and control 5200, Charging & EV related information and control 5300, Fleet Management & Telematics of vehicles related information and control 5400, or Delivery Management related information and control 5500).

The Engine 020 may implement a digital twin, or digital copy, of the system or sub-system that allows virtual data to correspond to real data, and provide a simulation platform for a user in a real-time environment or an offline environment. This may be accomplished by, for instance, the data feeds described above, and/or supplemented with additional sensors in the zone (or building, or vehicle). This data mirroring also allows not only on-site analysis, but also remote analysis, particularly if a user wishes to combine multiple zones or sub-zones to run the Engine 020 as one digital twin, or to split out a sub-zone to act as one digital twin for separate optimisation analysis. For example, digital twinning and simulation using the Engine 020 be useful for a user that wishes to test the combination of various incoming datasets or models, or other variables, such as setpoints, rules, or other control-based hierarchies for any zone devices or systems that consume energy (vehicle or non-vehicle). This includes energy or cost variables such as ToU, Demand response limits or charges, or end-use rate structures. It will be appreciated that equipment may have different rates associated with energy use, such as EV vs HVAC, in accordance with some embodiments.

In one embodiment, a digital twin may allow for virtual mapping of vehicles and charging status, such as an overlay the charge in the vehicle, location, operational capacity (e.g. available distance or time travelled based on battery life), and facility energy needs. This allows for what-if scenario planning, such as if a vehicle breaks, and can run a scenario as to which vehicle should be reallocated (and the corresponding impact on the facility, such as an immediate requirement for a fast-charge of new vehicle to deploy). This simulation allows a user to see impact on projected energy cost and, if necessary, consider additional facility changes in non-vehicle equipment use to offset the costs and ensure no additional DR penalties would occur. In a second example, the what-if scenario lets a user see the impact if portions of the zone are offline, such as if onsite generation capacity is removed, or vehicles removed from the pool to use, and the resulting impact of such decisions.

In operation, the digital twin simulation recommends control changes from the Engine 020, but also allows a user to run additional scenarios, such as letting a user account for unplanned fleet disruption (e.g. vehicle in accident, staffing disruptions, or the like), or unexpected energy rate or variable change (e.g. real-time pricing change due to major grid disruption, or local generation outage).

In accordance with another embodiment, a user may perform optimisation on a digital twin virtual model in accordance with the following steps:
1. Take inputs and aggregate data to form the digital twin virtual model, such as a Simulation Model of multiple independent operational zones or sub-zones for any portion of the system, such as BMS/EMS 5010, Connectivity Charging & Monitoring 5020, Fleet Telematics & Planning (GPS tracking; Delivery Management) 5030 that may interact with devices that require energy use (e.g. Energy-related information and control 5200, Charging & EV-related information and control 5300, Fleet Management & Telematics of vehicles and related information and control 5400, or Delivery Management related information and control 5500). In one embodiment, data may come from the system in the form of real-time data from sensors, databases, data lakes or the like, legacy data, onsite or offsite stored data, or other information sources relevant to the model.
2. Set operational boundaries, such as operational, financial, or other asset uses or limits to assist in this analysis and result in a more efficient charging approach to the vehicle(s) that considers important inputs such as fleet data, building data (or building attributes such as required energy needs), charge information, and/or energy cost or grid data.
3. Define and adjust Variables, such as operational, financial, or other asset-related variables, such as cost limits, cost sensitivity, availability of maintenance scheduling, staffing or resource variables, or other environmental variables.
4. Run Engine 020 simulation using the digital twin framework and provide analysis results to user.

The use of a digital twin across data zones and/or sub-zones of the system, in some embodiments, allows a user to analyze complex energy loads of physical assets, for example more predictable or static load related to day-to-day operation of a building and more dynamic loads such as electric vehicle charging of fleets which need future charges based on high variables from external influences as outlined earlier. Applying a digital twin simulation model to these combined systems provides a method to analyze and perform complex what-if scenarios in a simple way for a user, in accordance with some embodiments.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

1. A system for directing energy use within a facility comprising one or more charge stations for charging a fleet of electric vehicles, the system comprising:
an energy optimisation engine configured to receive as input:
energy supply data representative of energy supply characteristics over a first designated time period;
facility operation energy data representative of operational energy consumption characteristics of one or more energy assets associated with the facility over said first designated time period; and
vehicle operation data representative of electric vehicle operational requirements for one or more of the electric vehicles during a second designated time period;
one or more digital data processors accessible to said energy optimisation engine and configured to compute, for said first designated time period and satisfying a designated energy management condition corresponding at least in part with said energy supply characteristics, energy distribution instructions comprising:
charging instructions for the one or more charge stations satisfying said vehicle operational requirements; and
corresponding facility operation instructions for said energy assets;
wherein, for said first designated time period, said energy optimisation engine is configured to digitally direct operation of one or more of the charge stations or said energy assets in accordance with said energy distribution instructions.

2. The system of claim 1, wherein said first and second designated time periods correspond to at least partially overlapping time periods.

3. The system of claim 1, wherein said energy assets comprise one or more of an energy consuming device in the facility, an electrical load, or a utility.

4. The system of claim 1, wherein said charging instructions comprise one or more of a charge station activation, a charge station deactivation, a variable rate charge instruction, autonomous vehicle movement instructions, or manual vehicle movement instructions.

5. The system of claim 1, wherein said energy supply data comprises at least one of demand response data, an energy cost, a time-of-use penalty, an amount of energy, a demand penalty, or a predicted energy consumption.

6. The system of claim 1, wherein said facility operation data comprises at least one of a historical energy consumption, a current energy consumption, or a predicated energy consumption by at least one of said energy assets.

7. The system of claim 1, wherein said vehicle operation data comprises, for at least one of the electric vehicles, at least one of a battery capacity, a battery charge level, a rate of battery charge, a rate of battery discharge, a battery age, a battery temperature, a historical battery discharge rate, a distance to recharge, an expected vehicle weight, or data related to an expected vehicle route, a driving schedule, a driving distance, or driver.

8. The system of claim 1, wherein said energy distribution instructions comprise instructions to at least one of prioritize charging, discharging, or reschedule charging of at least one of the electric vehicles.

9. (canceled)

10. The system of claim 1, wherein said energy distribution instructions comprise instructions to discharge at least one battery of the electric vehicles into one or more of a different battery, an energy grid, the facility, or one or more of said energy assets.

11. The system of claim 1, wherein said energy optimisation engine is configured to receive as input electric vehicle charge network data representative of a vehicle charging location that is external to the facility, and wherein said energy optimisation engine is operable to compute said energy distribution instructions in view of said electric vehicle charge network data.

12. The system of claim 1, wherein said energy optimisation engine is operable to compute said energy distribution instructions in accordance with an artificial intelligence process.

13. The system of claim 1, wherein said one or more digital data processors are further configured to automatically compute delivery management recommendations based at least in part on said vehicle operational requirements and said energy distribution instructions.

14. The system of claim 1, wherein said one or more digital data processors are further operable to automatically compute vehicle charge requirements based at least in part on said vehicle operational requirements.

15. The system of claim 1, wherein said energy optimisation engine is configured to receive as input charging authorization for authorizing said operation of the charge stations.

16. The system of claim 1, wherein said electric vehicle charge optimisation engine is configured to receive as input asset direction authorization for authorizing said operation of the energy assets in the facility.

17. The system of claim 1, wherein said energy optimisation engine is configured to digitally direct operation of said one or more of the charge stations or said energy assets via a graphical user interface (GUI) displaying to a user data related to said energy distribution instructions; and
wherein said GUI is configured to receive as input execution data related to said energy distribution instructions to thereby implement at least a portion of said energy distribution instructions.

18. (canceled)

19. The system of claim 1, wherein said energy optimisation engine is configured to access one or more of a local server or a cloud-based server to receive as input therefrom one or more of said energy supply data, said facility operation data, said vehicle operation data, said first or said second time period, or said designated energy management condition.

20. The system of claim 19, further comprising one or more of said local server or said cloud-based server.

21. A method for directing energy use within a facility comprising one or more charging stations for charging a fleet of electric vehicles, the method digitally executed by an energy optimisation engine via one or more digital data processors and comprising:
receiving as input:
energy supply data representative of energy supply characteristics over a first designated time period;
facility operation energy data representative of operational energy consumption characteristics of one or more energy assets associated with the facility over said first designated time period; and
vehicle operation data representative of electric vehicle operational requirements for one or more of the electric vehicles during a second designated time period;
computing, for said first designated time period and satisfying a designated energy management condition corresponding at least in part with said energy supply characteristics, energy distribution instructions comprising:
charging instructions for the one or more charge stations satisfying said vehicle operational requirements; and
corresponding facility operation instructions for said energy assets; and
for said first designated time period, digitally directing operation of one or more of the charge stations or said energy assets in accordance with said energy distribution instructions.

22. (canceled)

23. (canceled)

24. (canceled)

25. (canceled)

26. (canceled)

27. (canceled)

28. (canceled)

29. (canceled)

30. The method of claim 21, wherein said energy distribution instructions comprise instructions to discharge at least one battery of the electric vehicles into one or more of another battery, an energy grid, the facility, another vehicle, or one or more of said energy assets.

31. (canceled)

32. (canceled)

33. (canceled)

34. (canceled)

35. (canceled)

36. (canceled)

37. (canceled)

38. (canceled)

39. (canceled)

40. (canceled)

41. A system for directing energy use for a facility associated with one or more charge stations for charging an electric vehicles, the system comprising:
a communications interface interfacing a digital processing resource with an external energy management interface;
one or more digital data processors configured to:
receive as input, in association with a designated time period:
energy supply data representative of energy supply characteristics;
facility operation energy data representative of energy usage requirements by at least one energy asset associated with the facility; and
vehicle operation data representative of electric vehicle operational requirements;
compute for said designated time period a designated energy distribution regime at least in part based on said vehicle operation data, said facility operation energy data, and said energy supply data;
via said communications interface, digitally direct operation of the one or more charge stations and said energy asset at least in part in accordance with said energy distribution regime.
